(19) United States
(12) Patent Application Publication
(10) Pub. No.: US 2024/0272454 A1
(43) Pub. Date: Aug. 15, 2024

(54) Longitudinal Chromatic Aberration Manipulation for Myopia Control

(71) Applicant: Clerio Vision, Inc., Rochester, NY (US)

(72) Inventors: Leonard Zheleznyak, Pittsford, NY (US); Gustavo A. Gandara-Montano, Rochester, NY (US)

(73) Assignee: Clerio Vision, Inc., Rochester, NY (US)

(21) Appl. No.: 18/440,488

(22) Filed: Feb. 13, 2024

Related U.S. Application Data
(60) Provisional application No. 63/445,464, filed on Feb. 14, 2023.
(60) Provisional application No. 63/514,471, filed on Jul. 19, 2023.

(51) Int. Cl. G02C 7/02

(52) U.S. Cl. CPC G02C 7/022; G02C 2202/24

(57) ABSTRACT

Ophthalmic lenses and related methods provide a longitudinal chromatic alteration for an eye to provide the eye with a stimulus to inhibit myopia progression or reverse myopia. An ophthalmic lens configured to inhibit progression of myopia in an eye or reduce myopia in the eye includes a subsurface optical structure. The ophthalmic lens is formed from a transparent material having a lens material refractive index. The subsurface optical structure includes refractive index spatial variations relative to the lens material refractive index to provide a chromatic alteration to reduce axial growth of the eye or decrease the axial length of the eye.

### CROSS REFERENCES TO RELATED APPLICATIONS

The present application claims priority to U.S. Provisional Patent Application Nos. 63/445,464 filed Feb. 14, 2023, and 63/514,471 filed Jul. 19, 2023; the full disclosures which are incorporated herein by reference in their entirety for all purposes.

### BACKGROUND

Myopia (aka nearsightedness) is an optical condition where close objects are seen clearly, and distant objects appear blurry. Myopia can result when the eyeball is excessively long and/or the cornea that is excessively curved so that light from a distant object is focused in front of the retina.

Myopia is the most common form of impaired vision under the age 40. The prevalence of myopia is growing at an alarming rate. It is estimated that about 25 percent of people in the world in the year 2000 were myopic. It is projected that about 50 percent of the people in the world in the year 2050 will be myopic.

Typically, myopia develops during childhood due to, at least in part, eye growth that occurs during childhood and progresses until about age 20. Myopia may also develop after childhood due to visual stress and/or health conditions such as diabetes.

A person with myopia has increased risk of other optical maladies. For example, a myopic person has significantly increased risk of developing cataracts, glaucoma, and/or retinal detachment. Additionally, many people with high myopia (often defined as myopia with a refractive error greater than −6 diopter) are not well-suited for LASIK or other laser refractive surgery.

### BRIEF SUMMARY

The following presents a simplified summary of some embodiments of the invention to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

FIG. 1 illustrates native longitudinal chromatic aberration (LCA) of an eye. The native LCA of an eye results in increased refraction of a blue-light wavelength (e.g., 430 nm) relative to a central reference wavelength (e.g., 550 nm) thereby producing a shorter focal length for the blue-light wavelength relative to a focal length for the central reference wavelength. Similarly, the native LCA of an eye typically results in decreased refraction of a red-light wavelength (e.g., 660 nm) relative to the central reference wavelength thereby producing a longer focal length for the red-light wavelength relative to the focal length for the central reference wavelength. When the central reference wavelength is in focus on the retina of the eye, the blue-light wavelength is focused in front of the retina and the red-light wavelength is focused behind the retina. The native LCA of an eye is due to the dispersion of the ocular media of an eye (i.e., the cornea, the aqueous, the crystalline lens, the vitreous), which are primarily composed of water. FIG. 1 shows representative plots of chromatic difference in focus (D) as functions of wavelength.

LCA has been shown to provide a stimulus as to the sign of defocus in the eye. The stimulus provided by LCA has been shown to be one of many redundant stimuli for driving accommodation, changes in retinal choroidal thickness, eye growth, and myopia progression. The color of light that is “in focus” on the retina has been shown to be related to changes in choroidal thickness. Changes in choroidal thickness have been shown to drive changes in the axial length of the eye. In emmetropes, when blue light is in focus on the retina, the eye is provided with a stimulus that the eye is too short and needs to keep growing. One mechanism for growing the axial length of the eye is thinning of the choroid, which is shown to occur in response to blue light being in focus on the retina. When red light is in focus on the retina, the eye is provided with a stimulus that the eye is too long, the choroid thickens, and the axial length decreases. FIG. 2 shows a plot (from Swiatczak, Barbara, and Frank Schaeffel. “Myopia: why the retina stops inhibiting eye growth.” Scientific Reports 12. 1 (2022): 1-9) of measured changes in ocular axial length for subjects that watched movies that were digitally filtered to present the red or blue image plane in best focus on the retina. For emmetropes, decreased eye length was observed in response to red light being in focus on the retina and increased eye length was observed in response to blue light being in focus on the retina. For myopes, no significant changes in eye length were observed for either red light being in focus on the retina or blue light being in focus on the retina.

In many embodiments, a diffractive subsurface optical structure is employed to manipulate the LCA of a user's eye to provide the eye with a stimulus that inhibits increase of the axial length of the eye to inhibit progression of myopia or decreases the axial length of the eye to decrease myopia. The diffractive subsurface optical structure can be configured to provide any suitable manipulation of the eye's LCA (e.g., correcting, reducing, reversing, increasing, doubling, etc.) to provide the eye with a stimulus that inhibits increases in the axial length of the eye or decreases the axial length of the eye. In many embodiments, the diffractive subsurface optical structure is formed via inducing subsurface changes in refractive index within a suitable ophthalmic lens, such as a contact lens. The subsurface changes in refractive index can be induced using any suitable approach, such as via a laser as described herein. In contrast to a surface topology implemented diffractive structure, a diffractive subsurface optical structure is not subject to detrimental tear film dynamics or scatter-inducing accumulation of debris, and therefore is suitable for manipulating LCA in an eye for myopia control.

Thus, in one aspect, an ophthalmic lens is configured to inhibit progression of myopia in an eye or reduce myopia in the eye. The ophthalmic lens includes a subsurface optical structure. The ophthalmic lens is formed from a transparent material having a lens material refractive index. The subsurface optical structure includes refractive indices that differ from the lens material refractive index to provide a chromatic alteration to reduce the rate of axial growth of the eye or decrease an axial length of the eye.

The ophthalmic lens can have any suitable configuration. For example, in many embodiments, the subsurface optical structure includes a diffractive structure configured to provide the chromatic alteration. In many embodiments, the subsurface optical structure is configured to provide a subsurface optical structure diffractive wavefront alteration. In many embodiments, the ophthalmic lens includes an exterior shape configured to provide an exterior shape refractive wavefront alteration. In many embodiments, the subsurface optical structure diffractive wavefront alteration and the exterior shape refractive wavefront alteration jointly provide a combined wavefront alteration with 0 diopter of optical power. In many embodiments, the subsurface optical structure diffractive wavefront alteration and the exterior shape refractive wavefront alteration jointly provide a positive diopter combined wavefront alteration. In many embodiments, the subsurface optical structure diffractive wavefront alteration and the exterior shape refractive wavefront alteration jointly provide a negative diopter combined wavefront alteration. In some embodiments, the ophthalmic lens includes an exterior shape configured to provide a zero diopter refractive wavefront alteration. In many embodiments, the subsurface optical structure is configured to provide a subsurface optical structure diffractive wavefront alteration.

In some embodiments, the subsurface optical structure includes a diffractive structure configured to provide a chromatic alteration. For example, in some embodiments, the subsurface optical structure includes a diffractive optical structure that provides a chromatic alteration. In some embodiments, the subsurface optical structure provides a wavefront correction including piston regions of different constant whole number optical phase in waves with respect to a reference wavelength and optical phase discontinuity regions. Each of the optical phase discontinuity regions can extend between and separates respective two immediately adjacent instances of the piston regions. The subsurface optical structure can provide a respective chromatic alteration correction for wavelengths that differ from the reference wavelength.

In many embodiments, the ophthalmic lens is configured to provide a wavefront alteration that is wavelength dependent. For example, the ophthalmic lens can be configured to defocus one or more blue-light wavelengths. The ophthalmic lens can include a blue-light defocus layer configured to defocus one or more blue-light wavelengths. In some embodiments, the subsurface optical structure is configured to decrease a focal length of a red-light wavelength and increase the focal length of a blue-light wavelength. In some embodiments, the subsurface optical structure is configured to decrease the focal length of the red-light wavelength relative to a focal length of a reference wavelength and increase the focal length of the blue-light wavelength relative to the focal length of the reference wavelength. In some embodiments, the subsurface optical structure is configured to reverse a native longitudinal chromatic aberration of the eye. In some embodiments, the subsurface optical structure is configured to increase a focal length of a red-light wavelength and decrease the focal length of a blue-light wavelength. In some embodiments, the subsurface optical structure is configured to double a native longitudinal chromatic aberration of the eye. In some embodiments, the subsurface optical structure is configured is configured to provide at least a 3.0 diopter diffractive wave front that provides the chromatic alteration. In some embodiments, the subsurface optical structure is configured is configured to provide at least a 6.0 diopter diffractive wave front that provides the chromatic alteration. In some embodiments, the subsurface optical structure is configured is configured to provide at least a 9.0 diopter diffractive wave front that provides the chromatic alteration.

In some embodiments, each of the sub-volumes of the subsurface optical structure has a respective refractive index spatial distribution so that the subsurface optical structure provides a wavefront correction comprising piston regions of different constant whole number optical phase in waves with respect to a reference wavelength and optical phase discontinuity regions. Each of the optical phase discontinuity regions can extend between and separate respective two immediately adjacent instances of the piston regions. The subsurface optical structure can provide a chromatic alteration correction for wavelengths that differ from the reference wavelength. In some embodiments, the subsurface optical structure provides no aberration correction for the reference wavelength. The piston regions can include a central piston region and annular piston regions that surround the central piston region. Each of the central piston region and the annular piston regions can be configured to have a different constant whole number optical phase in waves with respect to the reference wavelength. In some embodiments, the annular piston regions include three of the annular piston regions. In some embodiments, the annular piston regions include six of the annular piston regions. In some embodiments, the annular piston regions include nine of the annular piston regions. In some embodiments, each of the optical phase discontinuity regions provides a one optical wave discontinuity with respect to the reference wavelength. In some embodiments, the central piston region provides zero waves with respect to the reference wavelength.

The ophthalmic lens can be configured as any suitable type of ophthalmic lens. For example, in many embodiments, the ophthalmic lens is configured as a contact lens. In some embodiments, the ophthalmic lens can be configured as a contact lens configured to change the focal length of a reference wavelength to provide a vision correction for the user of the contact lens. In some embodiments, the ophthalmic lens is configured as an intraocular lens. In some embodiments, the ophthalmic lens is configured as an intraocular lens configured to change the focal length of a reference wavelength to provide a vision correction for the user of the intraocular lens. In some embodiments, the ophthalmic lens is configured as a spectacle lens. In some embodiments, the ophthalmic lens is configured as a spectacle lens configured to change the focal length of a reference wavelength to provide a vision correction for a user of the spectacle lens.

In another aspect, a method of producing an ophthalmic lens configured to inhibit progression of myopia in an eye or reducing myopia in the eye is provided. The method includes determining a chromatic alteration for reducing the rate of axial growth of the eye or decreasing the axial length of the eye, determining a subsurface optical structure for the ophthalmic lens for inducing the chromatic alteration, determining changes in subsurface refractive index for sub-volumes of the ophthalmic lens for forming the subsurface optical structure within the ophthalmic lens, and inducing the changes in subsurface refractive index in the sub-volumes of the ophthalmic lens to form the subsurface optical structure within the ophthalmic lens. In some embodiments, the method further includes receiving a definition of an optical correction for the eye at a reference wavelength and configuring the ophthalmic lens to provide the optical correction.

In many embodiments of the method, the ophthalmic lens is formed from a lens material having a lens material refractive index. The subsurface optical structure includes refractive indices that differ from the lens material refractive index to induce the chromatic alteration for wavelengths that differ from a reference wavelength. The subsurface optical structure can include a diffractive optical structure configured to induce the chromatic alteration for wavelengths that differ from a reference wavelength.

In many embodiments of the method, the subsurface optical structure includes a diffractive structure configured to provide the chromatic alteration. The subsurface optical structure can be configured to provide a subsurface optical structure diffractive wavefront alteration. In some embodiments of the method, the ophthalmic lens includes an exterior shape configured to provide an exterior shape refractive wavefront alteration. In some embodiments of the method, the subsurface optical structure diffractive wavefront alteration and the exterior shape refractive wavefront alteration jointly provide a combined wavefront alteration with 0 diopter of optical power. In some embodiments of the method, the subsurface optical structure diffractive wavefront alteration and the exterior shape refractive wavefront alteration jointly provide a positive diopter combined wavefront alteration. In some embodiments of the method, the subsurface optical structure diffractive wavefront alteration and the exterior shape refractive wavefront alteration jointly provide a negative diopter combined wavefront alteration.

In some embodiments of the method, the ophthalmic lens comprises an exterior shape configured to provide a zero diopter refractive wavefront alteration. And the subsurface optical structure can be configured to provide a subsurface optical structure diffractive wavefront alteration.

In some embodiments of the method, the subsurface optical structure provides a diffractive wavefront correction that includes piston regions of different constant whole number optical phase in waves with respect to a reference wavelength and optical phase discontinuity regions. Each of the optical phase discontinuity regions can extend between and separate respective two immediately adjacent instances of the piston regions. The subsurface optical structure can provide a respective chromatic alteration correction for wavelengths that differ from the reference wavelength.

In many embodiments of the method, the ophthalmic lens provides a wavefront correction that is wavelength dependent. For example, in many embodiments, the method further includes defocusing one or more blue-light wavelengths via the ophthalmic lens. In some embodiments of the method, the ophthalmic lens increases focus of one or more red-light wavelengths on a retina of the eye. In some embodiments of the method, the ophthalmic lens includes a blue-light defocus layer configured for defocusing one or more blue-light wavelengths. In some embodiments of the method the ophthalmic lens increases focus of one or more red-light wavelengths on a retina of the eye. In some embodiments of the method, the subsurface optical structure decreases a focal length of a red-light wavelength and increases a focal length of a blue-light wavelength. In some embodiments of the method, the subsurface optical structure decreases the focal length of the red-light wavelength to a focal length of a reference wavelength and increases the focal length of the blue-light wavelength to the focal length of the reference wavelength. In some embodiments of the method, the subsurface optical structure reverses the native longitudinal chromatic aberration of the eye. In some embodiments of the method, the subsurface optical structure increases focus of one or more red-light wavelengths on a retina of the eye. In some embodiments of the method, the subsurface optical structure decreases focus of one or more blue-light wavelengths on the retina. In some embodiments of the method, the subsurface optical structure doubles the native longitudinal chromatic aberration of the eye. In some embodiments of the method, the ophthalmic lens increases focus of one or more red-light wavelengths on both the macula of the retina of the eye and a peripheral location of the retina. In some embodiments of the method, the ophthalmic lens decreases focus of one or more blue-light wavelengths on both the macula and the peripheral retina.

In many embodiments of the method, each of the sub-volumes of the subsurface optical structure has a respective refractive index spatial distribution so that the subsurface optical structure provides a wavefront correction comprising piston regions of different constant whole number optical phase in waves with respect to a reference wavelength and optical phase discontinuity regions. Each of the optical phase discontinuity regions can extend between and separate respective two immediately adjacent instances of the piston regions. The subsurface optical structure can provide a respective aberration correction for wavelengths that differ from the reference wavelength. In some embodiments of the method, the subsurface optical structure provides no aberration correction for the reference wavelength. The piston regions can include a central piston region and annular piston regions that surround the central piston region and each of the central piston region and the annular piston regions is configured to have a different constant whole number optical phase in waves with respect to the reference wavelength. In some embodiments of the method, the annular piston regions include three of the annular piston regions. In some embodiments of the method, the annular piston regions include six of the annular piston regions. In some embodiments of the method, the annular piston regions include nine of the annular piston regions. In some embodiments of the method, each of the optical phase discontinuity regions provides a one optical wave discontinuity with respect to the reference wavelength. In some embodiments of the method, the central piston region provides zero waves with respect to the reference wavelength.

In many embodiments of the method, the ophthalmic lens can be configured as any suitable type of ophthalmic lens. For example, in many embodiments of the method, the ophthalmic lens is configured as a contact lens. In some embodiments of the method, the ophthalmic lens can be configured as a contact lens configured to change the focal length of a reference wavelength to provide a vision correction for a user of the contact lens. In some embodiments of the method, the ophthalmic lens is configured as an intraocular lens. In some embodiments of the method, the ophthalmic lens is configured as an intraocular lens configured to change the focal length of a reference wavelength to provide a vision correction for the user of the intraocular lens. In some embodiments of the method, the ophthalmic lens is configured as a spectacle lens. In some embodiments of the method, the ophthalmic lens is configured as a spectacle lens configured to change the focal length of a reference wavelength to provide a vision correction for a user of the spectacle lens.

In another aspect, an ophthalmic lens is configured to inhibit progression of myopia in an eye having a foveal retina and a peripheral retina or reduce myopia in the eye. The ophthalmic lens includes a central zone and an annular zone surrounding the central zone. The annular zone includes an annular zone subsurface optical structure. The ophthalmic lens is formed from a transparent material having a lens material refractive index. The annular zone subsurface optical structure comprises refractive indices that differ from the lens material refractive index to provide an annular zone chromatic alteration for light incident on the peripheral retina to reduce a rate of axial growth of the eye or decrease an axial length of the eye. In some embodiments, the central zone does not include a subsurface optical structure comprising refractive indices that differ from the lens material refractive index.

In many embodiment of the ophthalmic lens, the annular zone chromatic alteration decreases a focal length of a red-light wavelength and increases the focal length of a blue-light wavelength. In many embodiments, the annular zone subsurface optical structure is configured to provide at least a 3.0 diopter diffractive wave front that provides the annular zone chromatic alteration. The annular zone subsurface optical structure can be configured to provide at least a 6.0 diopter diffractive wave front that provides the annular zone chromatic alteration. The annular zone subsurface optical structure can be configured to provide at least a 9.0 diopter diffractive wave front that provides the annular zone chromatic alteration.

In many embodiment of the ophthalmic lens, the annular zone includes an exterior shape configured to provide an annular zone exterior shape refractive wavefront alteration. In some embodiments, the annular zone chromatic alteration and the annular zone exterior shape refractive wavefront alteration jointly provide a combined wavefront alteration with 0 diopter of optical power. In some embodiments, the annular zone chromatic alteration and the annular zone exterior shape refractive wavefront alteration jointly provide a positive diopter combined wavefront alteration. In some embodiments, the annular zone chromatic alteration and the annular zone exterior shape refractive wavefront alteration jointly provide a negative diopter combined wavefront alteration.

In many embodiment of the ophthalmic lens, the annular zone annular an exterior shape configured to provide a zero diopter annular zone refractive wavefront alteration. For example, the ophthalmic lens can have a constant thickness that extends over the central zone and the annular zone.

In many embodiment of the ophthalmic lens, the central zone includes a central zone subsurface optical structure comprising refractive indices that differ from the lens material refractive index to provide a central zone chromatic alteration for light incident on the foveal retina to reduce a rate of axial growth of the eye or decrease an axial length of the eye. In many embodiments, the central zone chromatic alteration decreases a focal length of a red-light wavelength and increases the focal length of a blue-light wavelength. In some embodiments, the central zone subsurface optical structure is configured to provide at least a 3.0 diopter diffractive wave front that provides the central zone chromatic alteration. The central zone subsurface optical structure can be configured to provide at least a 6.0 diopter diffractive wave front that provides the central zone chromatic alteration. The central zone subsurface optical structure can be configured to provide at least a 9.0 diopter diffractive wave front that provides the central zone chromatic alteration. In some embodiments, the central zone includes an exterior shape configured to provide a central zone exterior shape refractive wavefront alteration. In some embodiments, the central zone chromatic alteration and the central zone exterior shape refractive wavefront alteration jointly provide a combined wavefront alteration with 0 diopter of optical power. In some embodiments, the central zone chromatic alteration and the central zone exterior shape refractive wavefront alteration jointly provide a positive diopter combined wavefront alteration. In some embodiments, the central zone chromatic alteration and the central zone exterior shape refractive wavefront alteration jointly provide a negative diopter combined wavefront alteration.

The ophthalmic lens can have any suitable exterior shape. For example, in some embodiments the ophthalmic lens has a constant thickness. In some embodiments, the ophthalmic lens has an exterior shape with a varying thickness configured to provide an exterior shape refractive wavefront alteration.

In another aspect, a method of producing an ophthalmic lens configured to inhibit progression of myopia in an eye having a foveal retina and a peripheral retina or reducing myopia in the eye is provided. The method includes: (a) determining an annular zone chromatic alteration for light passing through an annular zone of the ophthalmic lens for light incident on the peripheral retina for reducing a rate of axial growth of the eye or decreasing an axial length of the eye, (b) determining an annular zone subsurface optical structure for the ophthalmic lens for inducing the annular zone chromatic alteration, (c) determining changes in subsurface refractive index for sub-volumes of the ophthalmic lens for forming the annular zone subsurface optical structure within the ophthalmic lens, and (d) inducing the changes in subsurface refractive index in the sub-volumes of the ophthalmic lens to form the annular zone subsurface optical structure within the ophthalmic lens. In some embodiments of the method, the central zone does not include a subsurface optical structure comprising variations in refractive index.

In many embodiments of the method, the annular zone chromatic alteration decreases a focal length of a red-light wavelength and increases the focal length of a blue-light wavelength. In some embodiments of the method, the annular zone subsurface optical structure is configured to provide at least a 3.0 diopter diffractive wave front that provides the annular zone chromatic alteration. The annular zone subsurface optical structure can be configured to provide at least a 6.0 diopter diffractive wave front that provides the annular zone chromatic alteration. The annular zone subsurface optical structure can be configured to provide at least a 9.0 diopter diffractive wave front that provides the annular zone chromatic alteration.

In many embodiments of the method, the annular zone includes an exterior shape configured to provide an annular zone exterior shape refractive wavefront alteration. In some embodiments of the method, the annular zone chromatic alteration and the annular zone exterior shape refractive wavefront alteration jointly provide a combined wavefront alteration with 0 diopter of optical power. In some embodiments of the method, the annular zone chromatic alteration and the annular zone exterior shape refractive wavefront alteration jointly provide a positive diopter combined wavefront alteration. In some embodiments of the method, the annular zone chromatic alteration and the annular zone exterior shape refractive wavefront alteration jointly provide a negative diopter combined wavefront alteration.

In some embodiments of the method, the annular zone includes an exterior shape configured to provide a zero diopter annular zone refractive wavefront alteration. For example, the annular zone can have a constant thickness.

In many embodiments, the method can further include: (a) determining a central zone chromatic alteration for light passing through a central zone of the ophthalmic lens for light incident on the foveal retina for reducing a rate of axial growth of the eye or decreasing an axial length of the eye, (b) determining a central zone subsurface optical structure for the ophthalmic lens for inducing the central zone chromatic alteration, (c) determining changes in subsurface refractive index for sub-volumes of the ophthalmic lens for forming the central zone subsurface optical structure within the ophthalmic lens, and (d) inducing the changes in subsurface refractive index in the sub-volumes of the ophthalmic lens to form the central zone subsurface optical structure within the ophthalmic lens. In many embodiments of the method, the central zone chromatic alteration decreases a focal length of a red-light wavelength and increases the focal length of a blue-light wavelength. In some embodiments of the method, the central zone subsurface optical structure is configured to provide at least a 3.0 diopter diffractive wave front that provides the central zone chromatic alteration. The central zone subsurface optical structure can be configured to provide at least a 6.0 diopter diffractive wave front that provides the central zone chromatic alteration. The central zone subsurface optical structure can be configured to provide at least a 9.0 diopter diffractive wave front that provides the central zone chromatic alteration.

The method can be to produce an ophthalmic lens having any suitable exterior shape. For example, in many embodiments of the method, the central zone includes an exterior shape configured to provide a central zone exterior shape refractive wavefront alteration. In some embodiments of the method, the ophthalmic lens has a constant thickness. In some embodiments of the method, the ophthalmic lens has an exterior shape with a varying thickness configured to provide an exterior shape refractive wavefront alteration.

For a fuller understanding of the nature and advantages of the present invention, reference should be made to the ensuing detailed description and accompanying drawings.

### BRIEF DESCRIPTION OF THE DRAWINGS

FIG. 1 illustrates longitudinal chromatic aberration of an eye.

FIG. 2 shows plots of measured changes in ocular axial length for subjects that watched movies that were digitally filtered to present the red or blue image plane in best focus.

FIG. 3 shows a cross-sectional view of an ophthalmic lens that includes a subsurface optical structure configured to induce a chromatic alteration to inhibit progression of myopia or reduce myopia, in accordance with embodiments.

FIG. 4 shows a plan view of the ophthalmic lens of FIG. 3.

Each of FIG. 5, FIG. 6, FIG. 7, and FIG. 8 shows a plot of longitudinal aberration of an eye with a contact lens that includes a subsurface diffractive optical structure as a function of optical power of the subsurface optical structure with respect to a respective example optical power provided by the subsurface diffractive optical structure.

FIG. 9 shows a simplified block diagram of a method of producing an ophthalmic lens configured to induce a chromatic alteration to inhibit progression of myopia or reduce myopia, in accordance with embodiments.

FIG. 10 shows plots of optical power as a function of wavelength for a representative emmetropic eye, a chromatic alteration for the eye, and a resulting residual chromatic aberration of the eye.

FIG. 11 shows plots of chromatic shift as a function of wavelength for a representative eye, a chromatically compensated eye, and an eye with a doubled chromatic aberration.

FIG. 12 shows plots of through-focus image quality for the chromatic shifts of FIG. 7.

FIG. 13 shows optical phase plots for an example design of a chromatic alteration inducing ophthalmic lens, in accordance with embodiments.

FIG. 14 shows plots of diffractive lens power for chromatic alteration inducing ophthalmic lenses as a function of ocular power, in accordance with embodiments.

FIG. 15 illustrates a longitudinal chromatic alteration generated by a lens.

FIG. 16 shows a plot of the longitudinal chromatic aberration (variation in optical power with wavelength) of an example myopic eye.

FIG. 17 shows a plot of longitudinal chromatic alteration (variation in optical power with wavelength) induced by a monofocal diffractive contact lens for the example myopic eye of FIG. 16.

FIG. 18 shows a plot of longitudinal chromatic aberration (variation in optical power with wavelength) of the combination of the example myopic eye of FIG. 16 and the monofocal diffractive contact lens of FIG. 17.

FIG. 19 shows a plot of Strehl Ratio versus focus for the corrected example myopic eye of FIG. 18 for each of three different wavelengths.

FIG. 20 shows plots of variation in optical power with wavelength for different lenses with different external shapes configured to provide different optical power corrections.

FIG. 21 shows plots of variation in optical power with wavelength for different subsurface diffractive optical structures configured to provide different optical power corrections.

FIG. 22 shows a plot of optical phase in waves (for a reference wavelength of 550 nm) versus radial coordinate for an example lens that induces a chromatic alteration.

FIG. 23 shows a plot of optical phase in waves (for a reference wavelength of 550 nm) versus radial coordinate for a phase-wrapped lens equivalent to the example lens of FIG. 22, using a phase-wrapping value of 1 wave.

FIG. 24 shows an example chromatic alteration inducing lens configured to alter or correct a chromatic aberration of an optical component or an optical system, in accordance with embodiments.

FIG. 25 show a simplified block diagram of a method of configuring a lens for altering or correcting a chromatic aberration, in accordance with embodiments.

FIG. 26 shows a plot of Strehl Ratio versus focus for each of three different wavelengths for the corrected example myopic eye of FIG. 18 combined with the chromatic alteration inducing lens of FIG. 20.

FIG. 27 shows another example chromatic alteration inducing lens configured for altering or correcting a chromatic aberration of an optical component or an optical system, in accordance with embodiments.

FIG. 28 shows a plot of optical phase in waves (for a reference wavelength of 550 nm) versus radial coordinate for an example chromatic alteration inducing subsurface diffractive optical structure, in accordance with embodiments.

FIG. 29 shows a plot of optical phase in waves versus radial coordinate for another chromatic alteration inducing subsurface diffractive optical structure, in accordance with embodiments.

FIG. 30 show a simplified block diagram of a method of configuring a lens for altering or correcting a chromatic aberration, in accordance with embodiments.

FIG. 31 shows another example chromatic alteration inducing lens configured for altering or correcting a chromatic aberration of an optical component or an optical system, in accordance with embodiments.

FIG. 32 shows plots of the maximum diameter of a chromatic alteration inducing subsurface diffractive optical structure that can be generated with a maximum phase available for several examples of dioptric powers of phase-wrapped optical structures that need to be subtracted from the corresponding continuous phase optical structure of the same dioptric power to generate the desired chromatic alteration inducing subsurface diffractive optical structure.

FIG. 33 shows a plot of the maximum phase necessary to create a 6 mm diameter chromatic alteration inducing subsurface diffractive optical structure as a function of the dioptric power of the phase-wrapped optical structure that needs to be subtracted from the continuous phase optical structure with the same dioptric power that generates the desired chromatic alteration inducing subsurface diffractive optical structure.

FIG. 34 shows plots of optical quality for different wavelengths as a function of defocus for myopes, emmetropes, and hyperopes for the foveal retina and the peripheral retina.

FIG. 35 shows plots of optical quality for emmetropes at different pupil diameters as a function of defocus for a 555 nm wavelength.

FIG. 36 shows a zonal diagram for a chromatic alteration inducing ophthalmic lens, in accordance with embodiments.

FIG. 37 show a simplified block diagram of a method of producing an ophthalmic lens configured to inhibit progression of myopia, in accordance with embodiments.

FIG. 38 is a schematic representation of a system that can be used to form subsurface optical elements within an ophthalmic lens, in accordance with embodiments.

FIG. 39 and FIG. 40 schematically illustrate another system that can be used to form subsurface optical elements within an ophthalmic lens, in accordance with embodiments.

FIG. 41 shows a plot that illustrates an example radial distribution of an optical correction for implementation via subsurface optical elements formed within an ophthalmic lens, in accordance with embodiments.

FIG. 42 shows a plot that illustrates a 1-wave phase wrapped distribution for the example optical correction of FIG. 41.

FIG. 43 illustrates a ⅓ wave ratio of the 1-wave phase wrapped distribution of FIG. 42.

FIG. 44 graphically illustrates diffraction efficiency for near focus and far focus versus optical phase height.

FIG. 45 graphically illustrates an example calibration curve for resulting optical phase change height as a function of laser pulse train optical power.

FIG. 46 is a plan view illustration of an ophthalmic lens that includes subsurface optical structures, in accordance with embodiments.

FIG. 47 is a plan view illustration of subsurface optical structures of the ophthalmic lens of FIG. 46.

FIG. 48 is a side view illustration of the subsurface optical structures of the ophthalmic lens of FIG. 47.

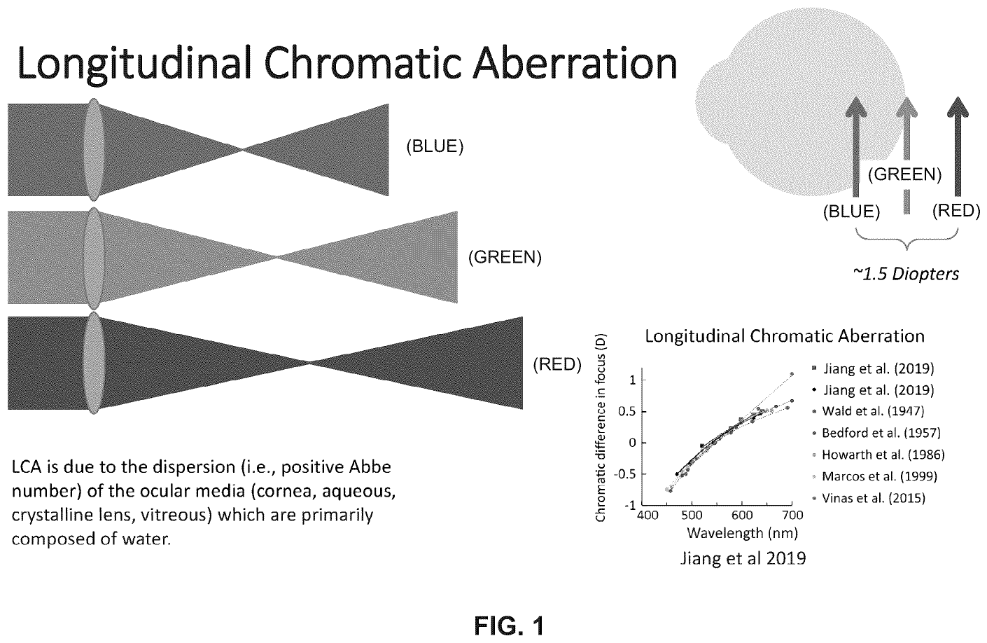

### DETAILED DESCRIPTION

In the description herein, various embodiments are described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

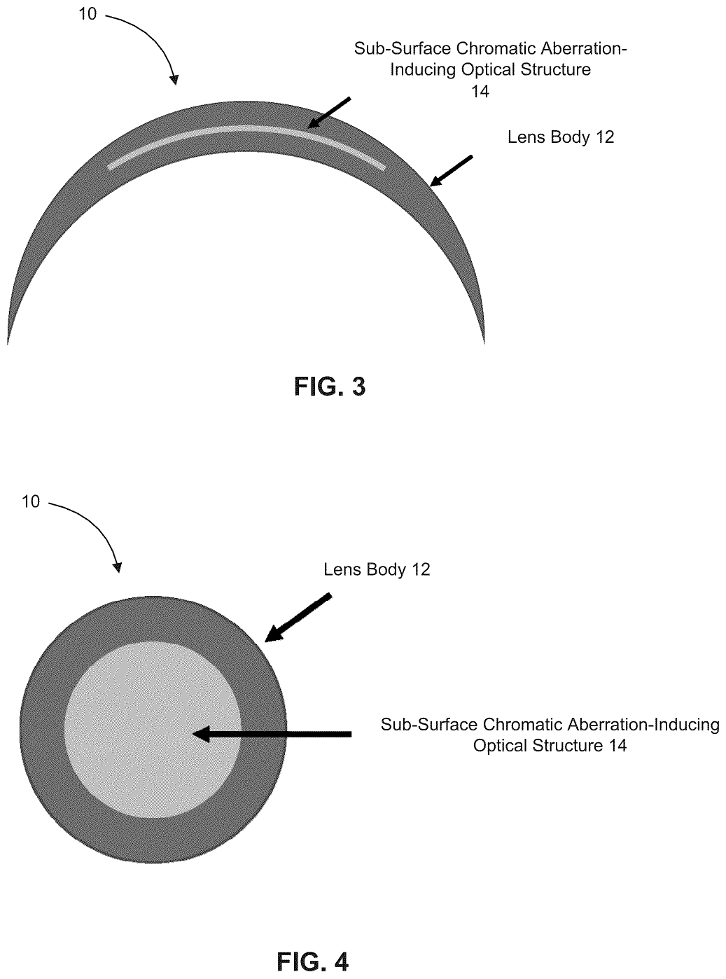

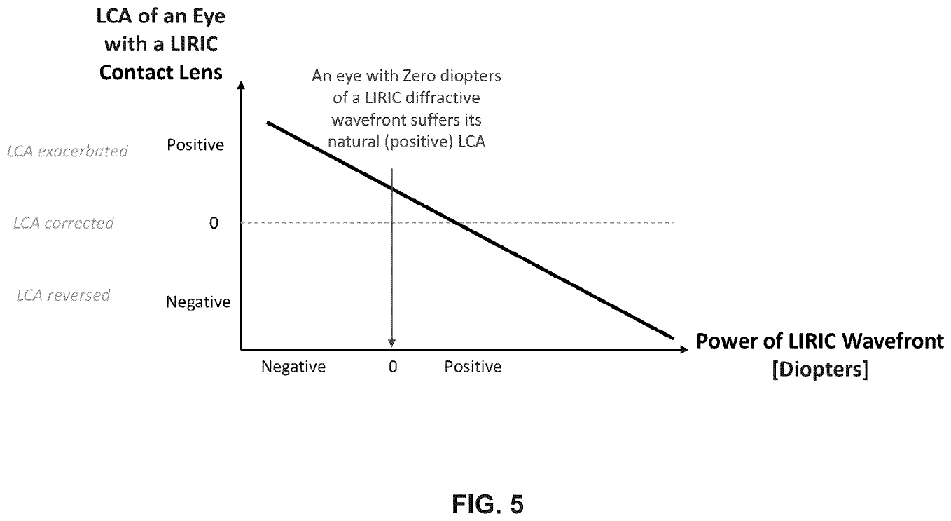

Turning now to the drawing figures in which similar reference numbers refer to similar features in the various drawing figures, FIG. 3 shows a cross-sectional view of an ophthalmic lens 10 that includes a lens body 12 and at least one subsurface optical structure 14 formed within the lens body 12. The at least one subsurface optical structure 14 is configured to provide a chromatic alteration to inhibit progression of myopia or reduce myopia. FIG. 4 shows a plan view of the ophthalmic lens 10. The lens body 12 can be made from any suitable lens material and have any suitable exterior shape for providing a refractive correction or no refractive correction. The at least one subsurface optical structure 14 can be configured to further provide any suitable refractive and/or diffractive correction for combination with the refractive correction provided by the lens body 12 via the exterior shape of the lens body 12 as described in more detail herein.

Each of FIG. 5, FIG. 6, FIG. 7, and FIG. 8 shows a plot of longitudinal aberration of an eye with an ophthalmic lens that includes a subsurface diffractive optical structure as a function of optical power of the subsurface optical structure with respect to a respective example optical power provided by the subsurface diffractive optical structure. As indicated in FIG. 5, an emmetropic eye has a natural LCA that is positive (i.e., blue wavelength with a shorter focal length than a red wavelength). As indicated in FIG. 6, an ophthalmic lens that produces a diffractive wavefront with approximately +3.0 diopter of optical power can be used to induce a longitudinal chromatic alteration that counteracts the natural LCA of the typical emmetropic eye to achromatize the typical emmetropic eye. As indicated in FIG. 7, an ophthalmic lens that produces a diffractive wavefront with approximately +6.0 diopter of optical power can be used to induce a longitudinal chromatic alteration that reverses the natural LCA of the typical emmetropic eye. As indicated in FIG. 8, an ophthalmic lens that produces a diffractive wavefront with approximately +9.0 diopter of optical power can be used to induce a longitudinal chromatic alteration that doubles the resulting LCA indicated in FIG. 7. Using the approaches described herein, the optical power provided by a diffractive wavefront used to achromatize an eye or optical system can be combined with an optical power produced via the exterior shape of the LCA altering ophthalmic lens to provide a desired net optical power to the eye or optical system.

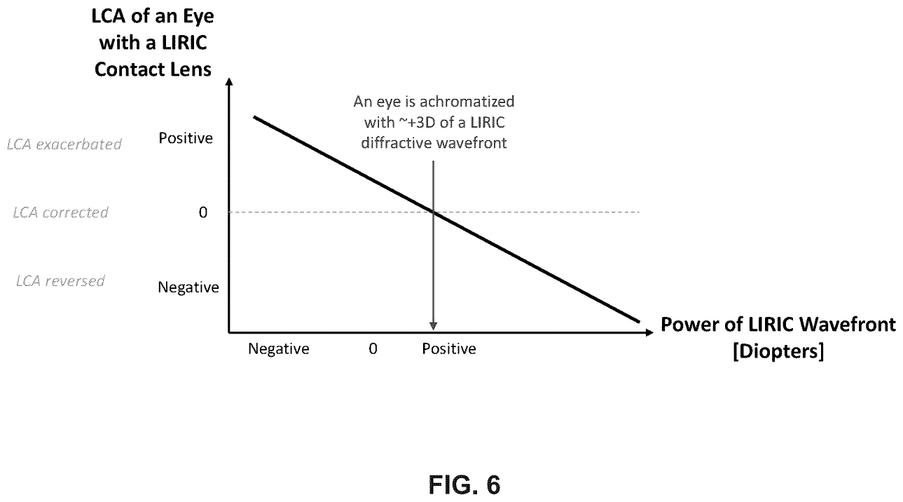

FIG. 9 shows a simplified block diagram of a method 20 of producing an ophthalmic lens configured to induce a chromatic alteration to inhibit progression of myopia or reduce myopia, in accordance with embodiments. The method 20 can be practiced using any suitable ophthalmic lens, such as the ophthalmic lens 10 described herein. In act 22, a definition for an ophthalmic lens configured to provide an optical correction for an eye is received. The optical correction can be any suitable optical correction for treating an optical condition of the eye, such as myopia, hyperopia, astigmatism, and/or presbyopia. The optical correction can also be no optical correction for an emmetropic eye. In act 24, a chromatic alteration is determined for combination with the optical correction for inducing a reduction of a rate of axial growth of the eye or a decrease in an axial length of the eye. For example, the chromatic alteration can be selected so that the combined wavefront alteration provided by the optical correction and the chromatic alteration is configured to increase focus of red light on the retina of the eye and/or decrease focus of blue light on the retina. In act 26, a subsurface optical structure, for forming within the ophthalmic lens, is defined for providing the chromatic alteration. Any suitable approach can be used to define the subsurface optical structure, such as the approaches described herein. In addition to providing the chromatic alteration, the subsurface optical structure can be configured to further provide a refractive correction as described herein. In act 28, changes in refractive index of sub-volumes of the ophthalmic lens are defined for forming the subsurface optical structure. Any suitable approach can be used to define the refractive index of sub-volumes of the ophthalmic lens including the approaches described herein. In act 30, changes in refractive index of the sub-volumes of the ophthalmic lens are induced to form the subsurface optical structure. Any suitable approach can be used to induce the changes in refractive index including the approaches described herein.

The ophthalmic lenses and approaches described herein can be used to provide a myopia progression inhibiting or myopia reducing wavefront alteration to an eye. In many embodiments, the ophthalmic lens is configured to modify the native LCA of the eye to provide a stimulus via the eye that induces a decrease in rate of growth of the axial length of the eye or a reduction in the axial length of the eye. In many embodiments, the ophthalmic lens includes a diffractive subsurface optical structure configured to induce a chromatic alteration to modify the native LCA of the eye. The ophthalmic lens can further provide a refractive correction via any suitable combination of the exterior shape of the ophthalmic lens and the diffractive subsurface optical structure.

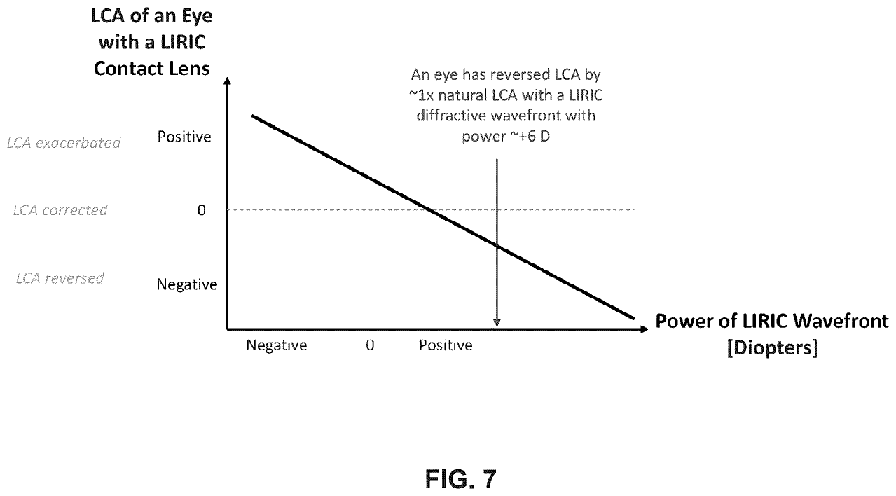

FIG. 10 is a plot (from Martinez, Jose L., et al. “Chromatic aberration control with liquid crystal spatial phase modulators” Optics Express 25. 9 (2017): 9793-9801) of power dispersion 32 for a naked eye, power dispersion 34 for a 3.2 diopter diffractive lens generated with a spatial light modulator (red), and a residual power dispersion 36 for the combination of the power dispersions 32, 34. As illustrated, the additional power dispersion 34 provided by the 3.2 diopter diffractive lens causes the residual power dispersion 36 to be minimized and almost flat in the range from 450 nm to 700 nm as shown.

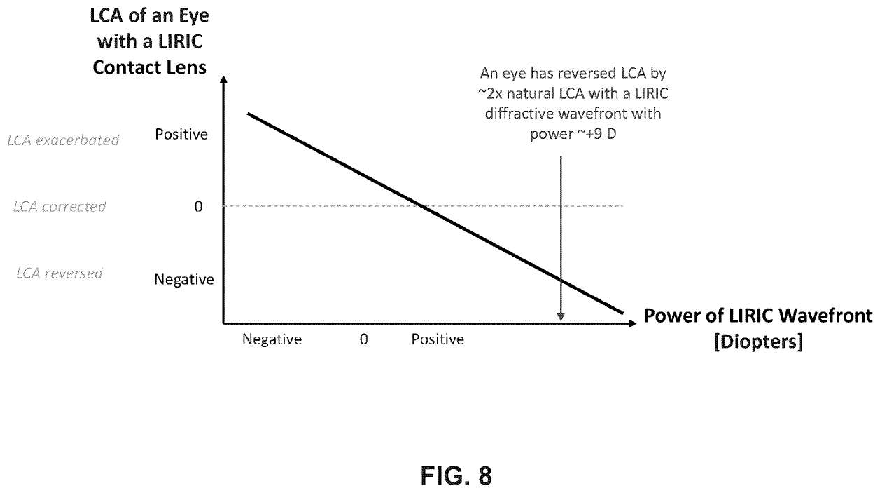

The chromatic condition of an eye can be altered in any suitable fashion (e.g., reducing LCA, substantially eliminating LCA, or increasing LCA) to inhibit the progression of myopia, reverse myopia, improve image quality, improve through-focus image quality, or any suitable combination of treating myopia and improving image quality. For example, FIG. 11 (from Suchkov, Nikolai; Enrique J. Fernandez; and Pablo Artal “Impact of longitudinal chromatic aberration on through-focus visual acuity” Optics Express 27. 24 (2019): 35935-35947) shows a plot 38 of native LCA of the typical human eye, a plot 40 of LCA of the typical human eye corrected by a diffractive optical wavefront, and a plot 42 of LCA of the typical human eye doubled by a diffractive optical wavefront. As shown plot 38, the native LCA of the typical human eye has approximately 1.5 diopters of defocus across the visible spectrum. For the corrected LCA shown in plot 40, the LCA correcting diffractive wavefront (which was implemented with a spatial light modulator) consisted of defocus (approximately +3 diopters) phase-wrapped at 1 optical wave at 555 nm wavelength. For the doubled LCA shown in plot 42, the diffractive wavefront employed (also implemented with a spatial light modulator) consisted of defocus (approximately −3 diopters) phase wrapped at 1 optical wave at 555 nm.

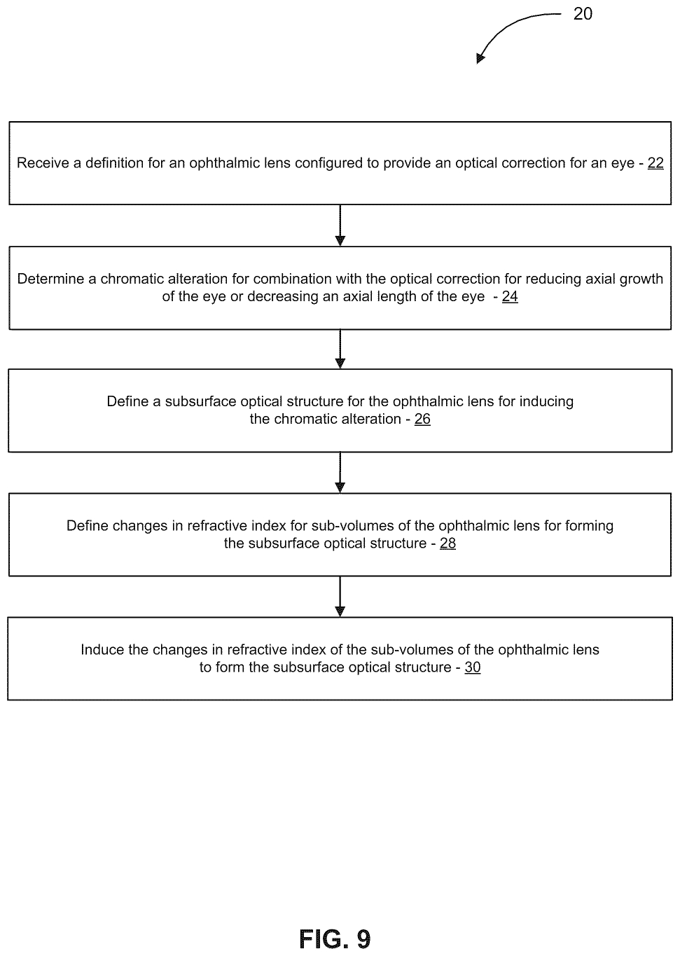

FIG. 12 shows plots 44, 46, 48 of through-focus image quality for the LCA conditions of FIG. 11. All three of the LCA conditions provide a peak in image quality at 0 diopters. As shown in plot 46, compensating LCA maximizes image quality and narrows depth of focus. As shown in plot 48, doubling LCA reduces image quality and extends depth of focus. While a significant impact on the peak of image quality was demonstrated, it was shown that LCA manipulation did not have a significant effect on high contrast visual acuity.

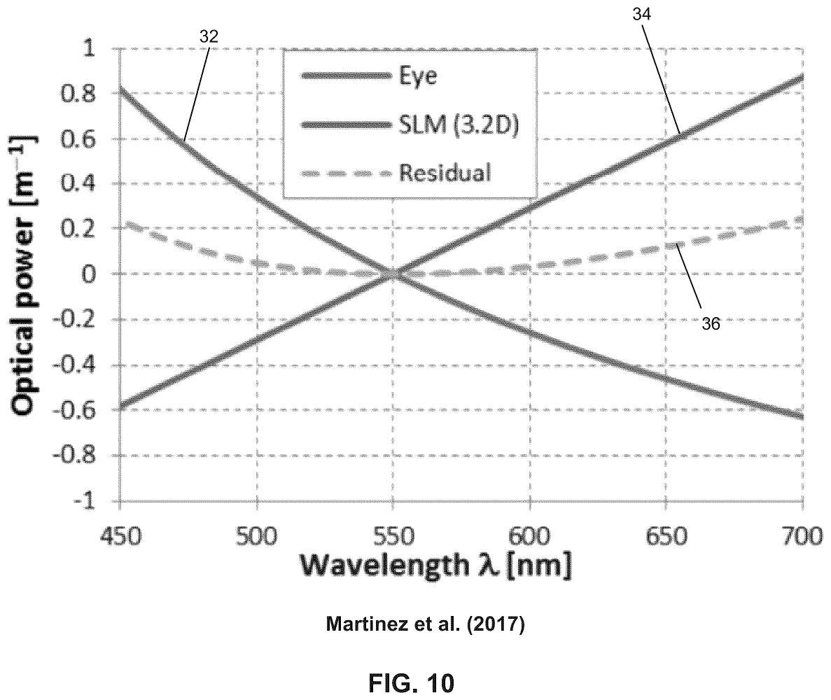

Any suitable combination of optical power correction (in diopters) and manipulation of LCA can be employed to inhibit the progression of myopia, reverse myopia, improve image quality, improve through-focus image quality, or any suitable combination of myopia treatment and image quality improvement. One approach for modifying LCA employs an ophthalmic lens with an exterior shape that provides a refractive correction. The ophthalmic lens includes one or more subsurface optical structures configured to modify LCA as described herein. In addition to being configured to modify LCA, the one or more subsurface optical structures can be configured to also provide an optical power correction. For example, FIG. 13 shows optical phase plots 50, 52, 54 for an example design of the chromatic aberration altering ophthalmic lens 10, in accordance with embodiments. In this example design, the exterior shape of the lens body 12 provides a −3.2 diopter optical correction, which is illustrated in optical waves in plot 50. The at least one subsurface optical structure 14 is configured to provide a diffractive wavefront for achromatizing the eye and provide a +3.2 diopter optical correction, which is illustrated in optical waves in plot 52. The +3.2 diopter optical correction provided by the at least one subsurface optical structure 14 combines with the −3.2 diopter optical correction provided by the exterior shape of the lens body 12 to provide no diopter optical correction for the emmetropic eye. Plot 54 shows the resulting wavefront in optical waves and is shown shifted from zero optical waves by 3.0 optical waves to avoid obscuring plot 52.

Example configurations for the lens 10 for providing different example combinations of optical power correction and LCA modification are summarized in Tables 1, 2, and 3 below. The Seidel Formula for LCA can be used to formulate suitable configurations for the lens 10 for providing any suitable combination of LCA modification and optical power correction.

### Seidel Formula for LCA:

$$LCA = sum [ Phi * {y}_{a}^{2} / Abbe \# ] = {LCA}_{eye} + {LCA}_{base \_ contact} + {LCA}_{LIRIC} {Y}_{a} \sim maximum pupil radius$$

To achromatize the eye:

$$LCA = 0$$

$$LCA = {LCA}_{eye} + {LCA}_{LIRIC}$$

$$Average power of the emmetropic eye = \sim 60 D$$

$$LCA = ( 60 D ) * {y}^{2} / Abbe \# + ( LIRIC power ) * {y}^{2} / Abbe \# = 0$$

$$60 D / Abbe {\#}_{eye} + ( LIRIC power ) / Abbe {\#}_{LIRIC} = 0$$

$$Abbe {\#}_{eye} \sim Abbe {\#}_{water} \sim 56$$

$$Abbe {\#}_{LIRIC} = Abbe {\#}_{diffractive} = - 3.45$$

$$LIRIC power = - 60 D * Abbe {\#}_{LIRIC} / Abbe {\#}_{water} = - 60 * - 3.45 / 56 = 3.7 D$$

TABLE 1
Ocular LCA Corrected.

| Subject | Ocular | Correction | Contact lens | LIRIC | Resultant |
|---|---|---|---|---|---|
| Category | Power | needed | base power | power | LCA |
| Emmetrope | 60 D | Plano | −3.7 D | +3.7 D | LCA = 0 |
| | | | | | (achro- |
| | | | | | matized eye) |
| Hyperope | 58 D | e.g. +2 D | −1.6 D | +3.6 D | LCA = 0 |
| | | | | | (achro- |
| | | | | | matized eye) |
| Myope | 62 D | e.g. −2 D | −5.8 D | +3.8 D | LCA = 0 |
| | | | | | (achro- |
| | | | | | matized eye) |
| High Myope | 70 D | e.g. −10 D | −14.3 D | +4.3 D | LCA = 0 |
| | | | | | (achro- |
| | | | | | matized eye) |

TABLE 2
Ocular LCA Reversed.

| Subject | Ocular | Correction | Contact lens | LIRIC |
|---|---|---|---|---|
| Category | Power | needed | base power | power |
| Emmetrope | 60 D | Plano | −7.4 D | +7.4 D |
| Hyperope | 58 D | e.g. +2 D | −5.2 D | +7.2 D |
| Myope | 62 D | e.g. −2 D | −9.7 D | +7.7 D |
| High Myope | 70 D | e.g. −10 D | −18.7 D | +8.7 D |

TABLE 3
Ocular LCA Doubled.

| Subject | Ocular | Correction | Contact lens | LIRIC |
|---|---|---|---|---|
| Category | Power | needed | base power | power |
| Emmetrope | 60 D | Plano | +3.7 D | −3.7 D |
| Hyperope | 58 D | e.g. +2 D | +5.6 D | −3.6 D |
| Myope | 62 D | e.g. −2 D | +1.8 | −3.8 D |
| High Myope | 70 D | e.g. −10 D | −5.7 D | −4.3 D |

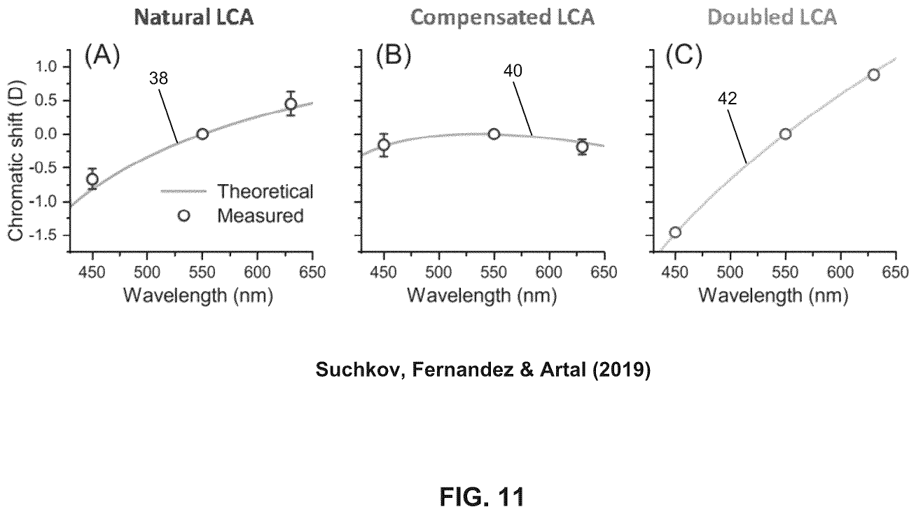

FIG. 14 shows plots 56, 58, 60 of diffractive lens power for the chromatic aberration altering ophthalmic lens 10 as a function of ocular power, in accordance with embodiments. Plot 56 shows the diffractive lens power for LCA correction as a function of total ocular power in diopter. Plot 58 shows the diffractive lens power for LCA reversal as a function of total ocular power in diopter. Plot 60 shows the diffractive lens power for LCA doubling as a function of total ocular power in diopter. FIG. 14 was constructed assuming that: 1) emmetropic eye power is equal to 60 D, 2) the Abbe Number of the eye is 55.74 (same as water), and 3) the Abbe Number for the diffractive subsurface optical structure is −3.45. The actual diffractive lens powers may differ from those shown in FIG. 14 due to differences in the actual Abbe Number of the eye, differences in the total ocular power of the eye, and/or differences in the native LCA of the eye. The at least one subsurface optical structure 14 of the ophthalmic lens 10 can be configured to modify LCA without providing any change in optical power.

### LCA Manipulation

While approaches described herein are directed to correction of LCA, the approaches can be modified to under correct LCA, over correct LCA, double LCA, or reverse LCA to implement LCA manipulation to inhibit progression of myopia or reverse myopia via focusing and/or defocusing of selected wavelengths of light relative to the retina. For example, in some embodiments, LCA can be manipulated to focus red light on the retina and defocus blue light to inhibit myopia or reverse myopia.

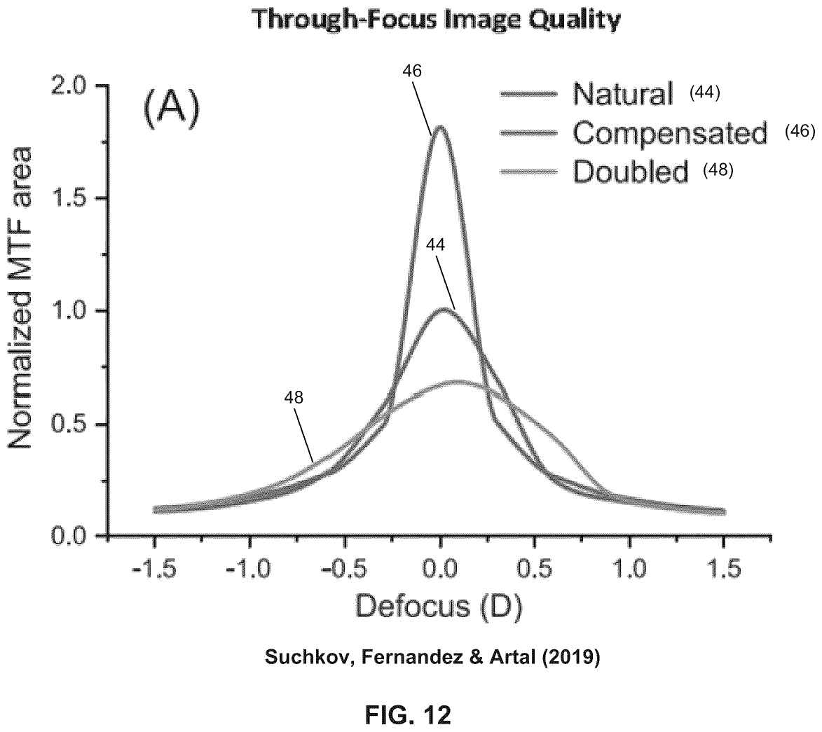

FIG. 15 illustrates longitudinal chromatic alterations generated by an example convex lens 110. Incoming parallel white light 112, which includes a blue light wavelength 114 (e.g., 450 nm), a green light wavelength 116 (e.g., 550 nm), and a red-light wavelength 118 (e.g., 650 nm), is converged by the convex lens 110. Due to the refractive index of the lens 110 being inversely proportional to wavelength, the blue light wavelength 114 is converged more than the green light wavelength 116, which is converged more than the red-light wavelength 118. As a result, the blue light wavelength 114, the green light wavelength 116, and the red-light wavelength 118 are focused to different focal points 120, 122, 124. Focusing different wavelengths of light to different points degrades image quality.

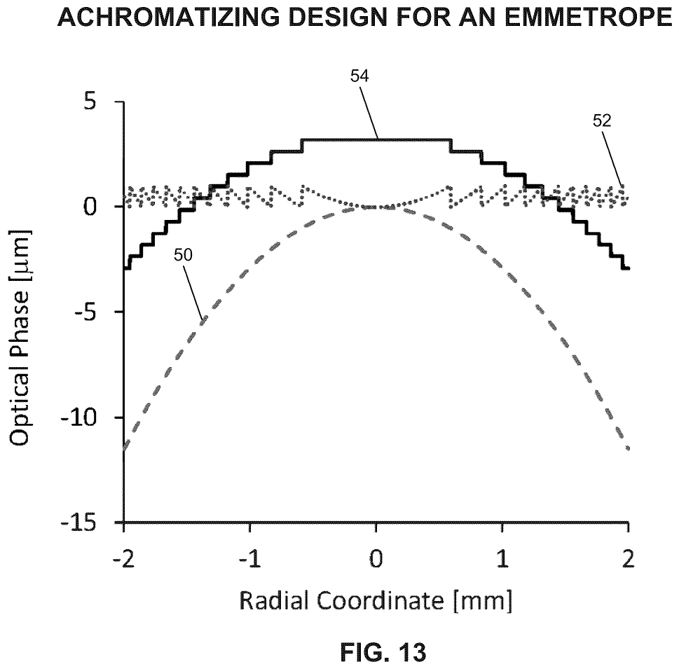

Chromatic aberrations are present in many existing optical systems. For example, FIG. 16 shows a plot 126 of variation in optical power with wavelength of an example uncorrected myopic eye. At the center wavelength (550 nm), the example uncorrected myopic eye provides 60.0 diopters of optical power. At 400 nm and 700 nm, the example uncorrected myopic eye provides 60.95 and 59.05 diopters of optical power, respectively.

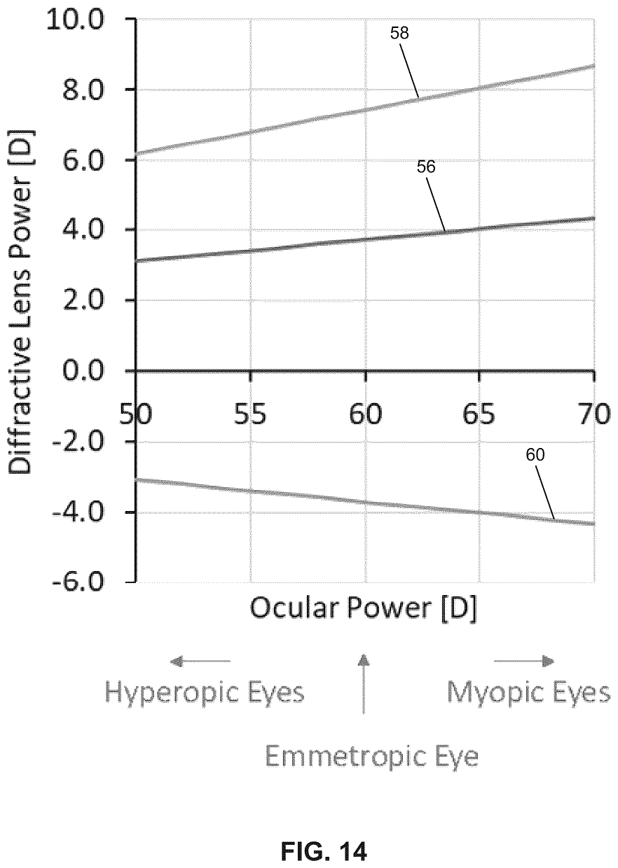

FIG. 17 shows a plot 128 of variation in optical power with wavelength of an example contact lens with a subsurface monofocal diffractive optical structure that can be employed to correct the example myopic eye. At the center wavelength (550 nm), the example contact lens provides −3.0 diopters of optical power. At 400 nm and 700 nm, the example contact lens provides −2.18 and −3.82 diopters of optical power, respectively.

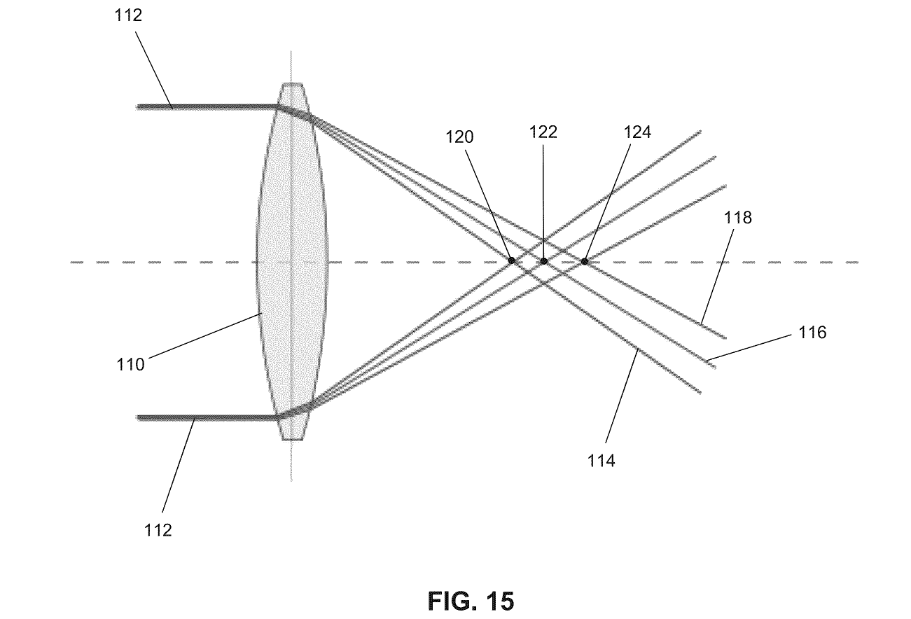

FIG. 18 shows a plot 130 of variation in optical power with wavelength of the combination of the example uncorrected myopic eye and the example contact lens. At the center wavelength (550 nm), the resulting corrected example eye provides −57.0 diopters of optical power. At 400 nm and 700 nm, the corrected example eye provides 58.77 and 55.23 diopters of optical power, respectively.

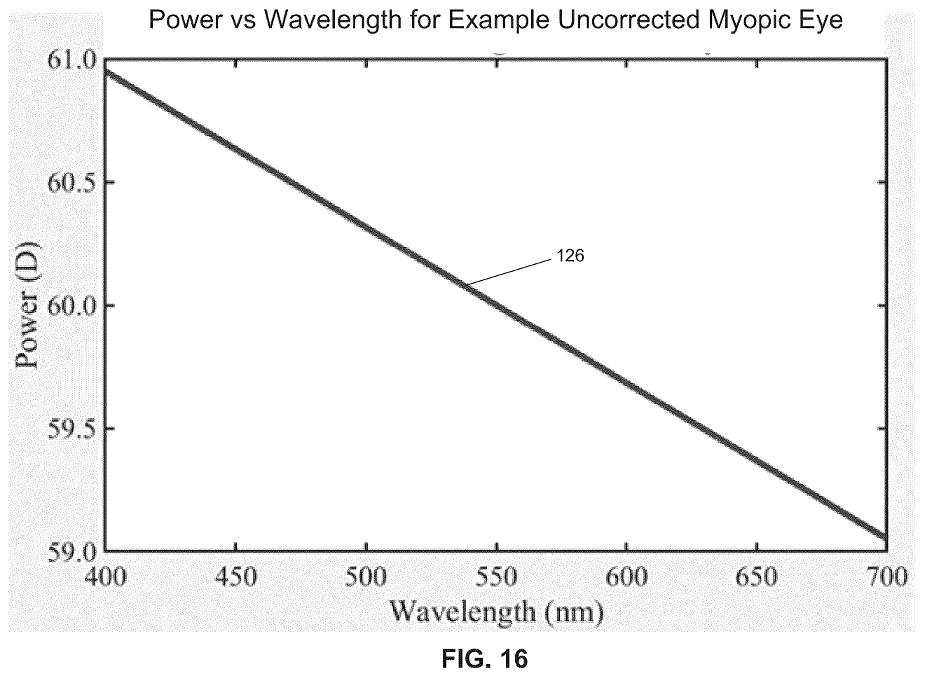

As a result of the variation of optical power of the example corrected eye with wavelength, the image quality provided by example corrected eye is suboptimal. FIG. 19 shows a plot of Strehl Ratio as a function of dioptric power for each of the three different wavelengths (450, 550, and 650 nm) for the example corrected eye of FIG. 18.

The magnitude of the chromatic aberration induced by an optical component or system can be quantified by the change in optical power (e.g., in diopters) divided by the change in wavelength (e.g., in nm). For an optical system, the total magnitude of chromatic aberration is equal to the sum of the chromatic aberrations induced by the constituent parts of the optical system.

In many embodiments, a chromatic alteration inducing lens is configured for use with an optical system to achromatize the optical system. In many embodiments, a chromatic alteration inducing lens includes a subsurface diffractive optical structure that induces a counter-acting chromatic alteration. The subsurface diffractive optical structure can further be configured to provide a desired optical power. The chromatic alteration inducing lens may further have an exterior shape configured to provide an optical power and induce a chromatic alteration (which can be counteracting or aggravating).

In the following example, a first example chromatic alteration inducing lens is configured as a contact lens for counteracting the chromatic aberration of an example corrected eye of FIG. 18. The first example chromatic aberration correcting contact lens includes a subsurface diffractive optical structure that provides an optical power at the central wavelength. The first example chromatic aberration correcting contact lens also has an exterior shape configured to provide an optical power and induce a chromatic alteration.

Equation (1) and equation (2) can be used to calculate the resulting residual chromatic aberration of an eye as the sum of the native chromatic aberration of the eye and the chromatic alteration induced by the contact lens.

$${( \frac{Δ P}{Δ λ} )}_{S y s t : e m} = {( \frac{Δ P}{Δ λ} )}_{E y e} + {( \frac{Δ P}{Δ λ} )}_{Contact} \qquad Equation ( 1 )$$

$${( \frac{Δ P}{Δ λ} )}_{C o n t : a c t :} = {( \frac{Δ P}{Δ λ} )}_{Contact lens shape} + {( \frac{Δ P}{Δ λ} )}_{subsurface structure} \qquad Equation ( 2 )$$

wherein

$$( \frac{Δ P}{Δ λ} ) = change in optical power per change in wavelength ;$$

$${( \frac{Δ P}{Δ λ} )}_{System} = resulting residual chromatic aberration of the corrected eye ;$$

$${( \frac{Δ P}{Δ λ} )}_{E y e} = native chromatic aberration of the eye ;$$

$${( \frac{Δ P}{Δ λ} )}_{Contact} = chromatic alteration induced by the contact lens ;$$

$${( \frac{Δ P}{Δ λ} )}_{Contact lens shape} = chromatic alteration induced by the contact lens shape ;$$

$${( \frac{Δ P}{Δ λ} )}_{s ubsurface structure} = chromatic alteration induced by the contact lens subsurface optical structure .$$

Equation (3) can be used to estimate the native chromatic aberration of the eye.

$${( \frac{Δ P}{Δ λ} )}_{e y e} = ( {P}_{d , e y e} ) ( \frac{1}{{v}_{water}} ) ( \frac{1}{{λ}_{F} - {λ}_{C}} ) \qquad Equation ( 3 )$$

wherein:

Equation 3 is premised on ν_{eye}≅ν_{water}

(P_{d,eye})=optical power of the eye at the central wavelength;

ν_{water}=Abbe number of water (approximation of the Abbe number of the eye)

λ_{F}=486.1 nm (blue Fraunhofer F line from hydrogen)

λ_{C}=656.3 nm (red Fraunhofer C line from hydrogen)

Equation (4) can be used to estimate the chromatic alteration induced by the contact lens shape.

$${( \frac{Δ P}{Δ λ} )}_{contact lens shape} = ( {P}_{d , contact lens shape} ) ( \frac{1}{{v}_{water}} ) ( \frac{1}{{λ}_{F} - {λ}_{C}} ) \qquad Equation ( 4 )$$

wherein:

Equation 4 is premised on ν_{contact}=ν_{water}

(P_{d,contac lens shape})=optical power provided by the contact lens shape at the central wavelength;

ν_{water}=Abbe number of water (approximation of the Abbe number of the contact)

λ_{F}=486.1 nm (blue Fraunhofer F line from hydrogen)

λ_{C}=656.3 nm (red Fraunhofer C line from hydrogen)

Equation (5) can be used to estimate the chromatic alteration induced by the contact lens subsurface diffractive optical structure.

Equation (5):

$${( \frac{Δ P}{Δ λ} )}_{subsurface structure} = \frac{{P}_{subsurface structure at central wavelength}}{{λ}_{central}}$$

wherein:
(P_{subsurface structure at central wavelength})=optical power provided by the subsurface structure at the central wavelength;
λ_{central}=the central wavelength

Setting the resulting residual chromatic aberration of the corrected eye to zero in equation (1) results in two remaining variables to be solved for (i.e., the optical power (at the central wavelength) provided by the contact lens shape and the optical power (at the central wavelength) provided by the subsurface optical structure). Since the total optical power provided by the contact lens is equal to the sum of the optical power provided by the lens shape and the optical power provided by the subsurface diffractive optical structure, the desired total resulting power of the contact lens for a given eye provides a second equation that relates the power provided by the contact lens shape and the power provided by the subsurface diffractive optical structure. For the example myopic eye of FIG. 16 for which the desired total resulting power of the contact lens is −3.0 diopters, the optical power provided by the contact lens shape added to the optical power provided by the subsurface diffractive optical structure is equal to −3.0 diopters. As a result, the combination of equation (1) and knowing the desired total resulting power of the contact lens provides two equations and two unknowns (i.e., the optical power provided by the contact lens shape and the optical power provided by the subsurface diffractive optical structure).

For the example myopic eye of FIG. 16, the chromatic aberration can be obtained directly from FIG. 16. At 400 nm, the optical power of the example myopic eye is 60.95 diopters. At 700 nm, the optical power of the example myopic eye is 59.05. Therefore, the chromatic aberration of the example myopic eye (i.e., change in optical power per change in wavelength) is:

$${( \frac{Δ P}{Δ λ} )}_{E y e} = \frac{59.05 diopters - 60.95 diopters}{700 nm - 400 nm} = - 0.0063 \frac{d i o p t e r s}{n m}$$

The chromatic aberration of the example myopic eye of FIG. 16 can also be calculated using equation (3).

$${( \frac{Δ P}{Δ λ} )}_{eye} = ( {P}_{d , eye} ) ( \frac{1}{{v}_{water}} ) ( \frac{1}{{λ}_{F} - {λ}_{C}} )$$

$${( \frac{Δ P}{Δ λ} )}_{eye} = ( 60 diopters ) ( \frac{1}{55.74} ) ( \frac{1}{486.1 nm - 656.3 nm} ) = - \text{.0063} \frac{diopters}{nm}$$

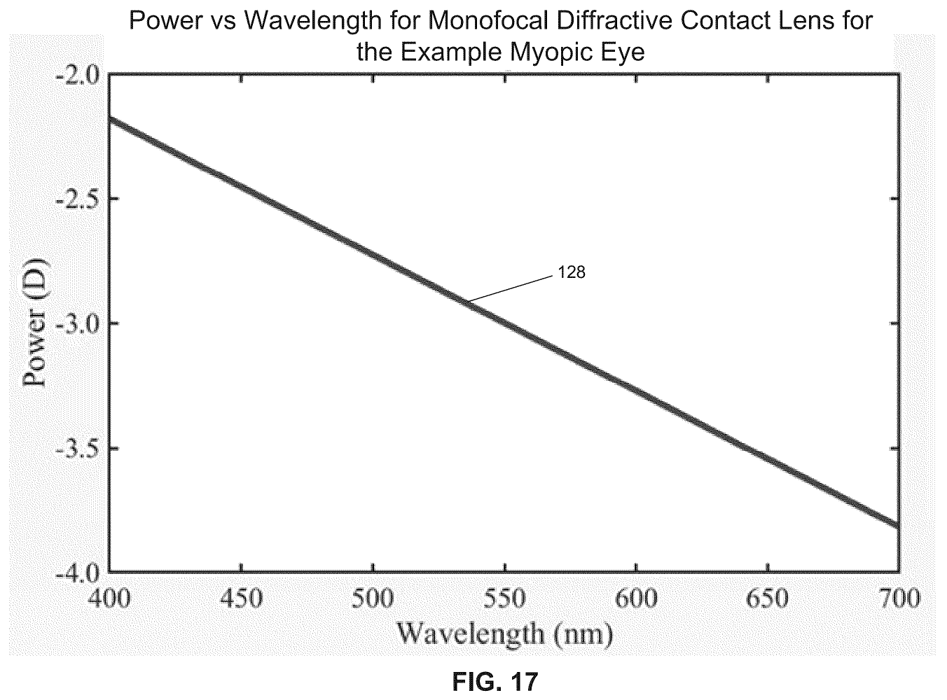

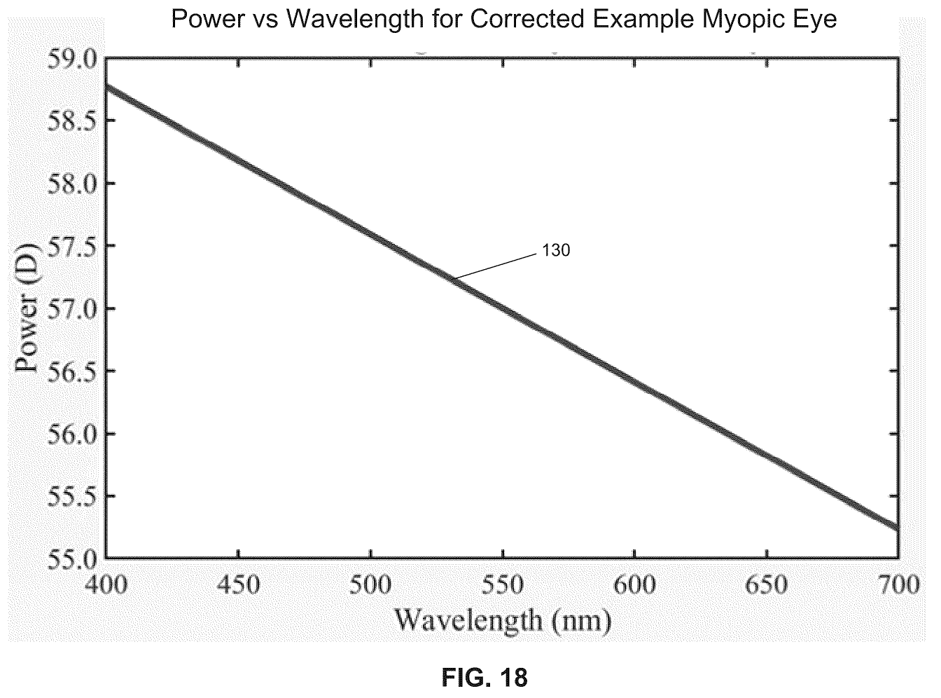

To achromatize and correct the example myopic eye, the first example chromatic aberration correcting contact lens can be configured to provide a −3.0 diopter correction at the central wavelength and to induce a counter-acting chromatic alteration of 0.0063 diopters/nm. The first example chromatic aberration correcting contact lens can be configured using FIG. 20 and FIG. 21 to have an exterior shape that provides a −6.12 diopter power (produces 0.0006 diopter/nm chromatic correction) combined with a subsurface diffractive optical element that provides 3.12 diopter power (produces 0.0057 diopter/nm) to produce a combined −3.0 diopter power and 0.0063 diopter/nm chromatic correction for correcting and achromatizing the example myopic eye of FIG. 16.

FIG. 20 shows plots 132, 134, 136, 138, 140, 142, 144, 146 of variation in optical power with wavelength for different example lenses (made of a contact lens material with an Abbe number approximately that of water (i.e., 55.74)) with different external shapes configured to provide different optical powers. The lens of plot 132 provides −7.0 diopter at the central wavelength and 0.00074 diopters/nm chromatic correction (−7.11 diopter at 400 nm, −7.0 diopter at 550 nm, and −6.89 diopter at 700 nm). The lens of plot 134 provides −5.0 diopter at the central wavelength and 0.00053 diopters/nm chromatic correction (−5.08 diopter at 400 nm, −5.0 diopter at 550 nm, and −4.92 diopter at 700 nm). The lens of plot 136 provides −3.0 diopter at the central wavelength and 0.00032 diopters/nm chromatic correction (−3.05 diopter at 400 nm, −3.0 diopter at 550 nm, and −2.95 diopter at 700 nm). The lens of plot 138 provides −1.0 diopter at the central wavelength and 0.00011 diopters/nm chromatic correction (−1.02 diopter at 400 nm, −1.0 diopter at 550 nm, and −0.98 diopter at 700 nm). The lens of plot 140 provides 1.0 diopter at the central wavelength and −0.00013 diopters/nm chromatic correction (1.02 diopter at 400 nm, 1.0 diopter at 550 nm, and 0.98 diopter at 700 nm). The lens of plot 142 provides 3.0 diopter at the central wavelength and −0.00032 diopters/nm chromatic correction (3.05 diopter at 400 nm, 3.0 diopter at 550 nm, and 2.95 diopter at 700 nm). The lens of plot 144 provides 5.0 diopter at the central wavelength and −0.00053 diopters/nm chromatic correction (5.08 diopter at 400 nm, 5.0 diopter at 550 nm, and 4.92 diopter at 700 nm). The lens of plot 146 provides 7.0 diopter at the central wavelength and −0.00074 diopters/nm chromatic correction (7.11 diopter at 400 nm, 7.0 diopter at 550 nm, and 6.89 diopter at 700 nm).

FIG. 21 shows plots 148, 150, 152, 154, 156, 158, 160, 162 of variation in optical power with wavelength for different subsurface diffractive optical structures configured to provide different optical powers. The subsurface diffractive optical structure of plot 148 provides −7.0 diopter at the central wavelength and −0.01273 diopters/nm chromatic correction (−5.09 diopter at 400 nm, −7.0 diopter at 550 nm, and −8.91 diopter at 700 nm). The subsurface diffractive optical structure of plot 150 provides −5.0 diopter at the central wavelength and −0.00909 diopters/nm chromatic correction (−3.64 diopter at 400 nm, −5.0 diopter at 550 nm, and −6.36 diopter at 700 nm). The subsurface diffractive optical structure of plot 152 provides −3.0 diopter at the central wavelength and −0.00545 diopters/nm chromatic correction (−2.18 diopter at 400 nm, −3.0 diopter at 550 nm, and −3.82 diopter at 700 nm). The subsurface diffractive optical structure of plot 154 provides −1.0 diopter at the central wavelength and −0.00182 diopters/nm chromatic correction (−0.73 diopter at 400 nm, −1.0 diopter at 550 nm, and −1.27 diopter at 700 nm). The subsurface diffractive optical structure of plot 156 provides 1.0 diopter at the central wavelength and 0.00182 diopters/nm chromatic correction (0.73 diopter at 400 nm, 1.0 diopter at 550 nm, and 1.27 diopter at 700 nm). The subsurface diffractive optical structure of plot 158 provides 3.0 diopter at the central wavelength and 0.00545 diopters/nm chromatic correction (2.18 diopter at 400 nm, 3.0 diopter at 550 nm, and 3.82 diopter at 700 nm). The subsurface diffractive optical structure of plot 160 provides 5.0 diopter at the central wavelength and 0.00909 diopters/nm chromatic correction (3.64 diopter at 400 nm, 5.0 diopter at 550 nm, and 6.36 diopter at 700 nm). The subsurface diffractive optical structure of plot 162 provides 7.0 diopter at the central wavelength and 0.01273 diopters/nm chromatic correction (5.09 diopter at 400 nm, 7.0 diopter at 550 nm, and 8.91 diopter at 700).

To achromatize and correct an example myopic eye that requires a −6.0 diopter correction, a second example chromatic aberration correcting contact lens can be configured to provide a −6.0 diopter correction at the central wavelength and to induce a counter-acting chromatic alteration to achromatize the example myopic eye. Assuming the example myopic eye provides 60.0 diopters of optical power, the chromatic aberration of the example myopic eye can be estimated using equation (3).

$${( \frac{Δ P}{Δ λ} )}_{eye} = ( {P}_{d , eye} ) ( \frac{1}{{v}_{water}} ) ( \frac{1}{{λ}_{F} - {λ}_{C}} )$$

$${( \frac{Δ P}{Δ λ} )}_{eye} = ( 60 diopters ) ( \frac{1}{55.74} ) ( \frac{1}{486.1 nm - 656.3 nm} ) = - \text{.0063} \frac{diopters}{nm}$$

Using FIG. 20 and FIG. 21 the second example chromatic aberration correcting contact lens can be configured to have an exterior shape that provides a −8.96 diopters of power (produces about 0.000944 diopter/nm chromatic correction) combined with a subsurface diffractive optical element that provides 2.96 diopters of power (produces 0.00538 diopter/nm) to produce a combined −6.0 diopters of power and 0.0063 diopter/nm chromatic correction for correcting and achromatizing the example hyperopic eye.

### Subsurface Diffractive Optical Structure

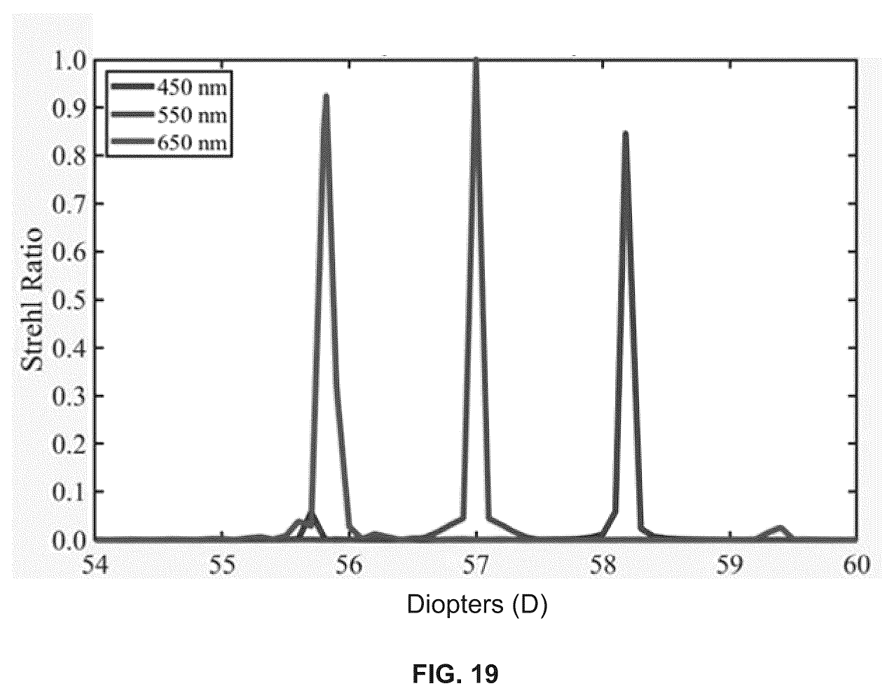

FIG. 22 illustrates a plot 164 of optical phase in waves (for a reference wavelength of 550 nm) versus radial coordinate for an example convex lens, which generates a chromatic alteration. A wavefront correction provided by a lens can be quantified using the change in optical phase in waves, as a function of spatial coordinate, provided by the lens. In geometrical optics, a wavefront is a surface with equal optical phase. Since the refractive index of a lens material is inversely proportional to the wavelength of light passing through the lens, the change in optical phase (waves) produced for each light ray passing through the lens is inversely proportional to the wavelength of light passing through the lens. For illustrative purposes, equation (1) reflects an assumed linear inverse relationship between the change in optical phase (waves) produced for each light ray passing through the lens and the wavelength of light passing through the lens. Table 4 lists changes in optical phase (waves) at different wavelengths for the example convex lens of FIG. 22 calculated using the assumed linear relationship reflected in equation (6).

$$Δ P h a s {e}_{λ} = Δ P h a s {e}_{r e f λ} ( 1 + {K}_{m} \frac{( λ - {λ}_{r e f} )}{{λ}_{r e f}} ) \qquad Equation ( 6 )$$

wherein: ΔPhase_{λ}=change in phase provided at a particular wavelength;

ΔPhase_{refλ}=change in phase provided at the reference wavelength;

Kₘ=material constant for change in phase for the lens material;

λ_{ref}=the reference (design) wavelength; and

λ=the particular wavelength

TABLE 4
Changes in optical phase at different wavelengths
for the example convex lens of FIG. 22.

| 450 nm | 500 nm | 550 nm | 600 nm | 650 nm |
|---|---|---|---|---|
| 0.00 | 0.00 | 0.00 | 0.00 | 0.00 |
| −1.00 − 0.18Kₘ | −1.00 − 0.09Kₘ | −1.00 | −1.00 + 0.09Kₘ | −1.00 + 0.18Kₘ |
| −2.00 − 0.36Kₘ | −2.00 − 0.18Kₘ | −2.00 | −2.00 + 0.18Kₘ | −2.00 + 0.36Kₘ |
| −3.00 − 0.55Kₘ | −3.00 − 0.27Kₘ | −3.00 | −3.00 + 0.27Kₘ | −3.00 + 0.55Kₘ |
| −4.00 − 0.73Kₘ | −4.00 − 0.36Kₘ | −4.00 | −4.00 + 0.36Kₘ | −4.00 + 0.73Kₘ |
| −5.00 − 0.91Kₘ | −5.00 − 0.45Kₘ | −5.00 | −5.00 + 0.45Kₘ | −5.00 + 0.91Kₘ |
| −6.00 − 1.09Kₘ | −6.00 − 0.55Kₘ | −6.00 | −6.00 + 0.55Kₘ | −6.00 + 1.09Kₘ |
| −7.00 − 1.27Kₘ | −7.00 − 0.64Kₘ | −7.00 | −7.00 + 0.64Kₘ | −7.00 + 1.27Kₘ |
| −8.00 − 1.45Kₘ | −8.00 − 0.73Kₘ | −8.00 | −8.00 + 0.73Kₘ | −8.00 + 1.45Kₘ |
| −9.00 − 1.64Kₘ | −9.00 − 0.82Kₘ | −9.00 | −9.00 + 0.82Kₘ | −9.00 + 1.64Kₘ |
| −10.00 − 1.82Kₘ | −10.00 − 0.91Kₘ | −10.00 | −10.00 + 0.91Kₘ | −10.00 + 1.82Kₘ |
| −11.00 − 2.00Kₘ | −11.00 − 1.00Kₘ | −11.00 | −11.00 + 1.00Kₘ | −11.00 + 2.00Kₘ |
| −12.00 − 2.18Kₘ | −12.00 − 1.09Kₘ | −12.00 | −12.00 + 1.09Kₘ | −12.00 + 2.18Kₘ |
| −13.00 − 2.36Kₘ | −13.00 − 1.18Kₘ | −13.00 | −13.00 + 1.18Kₘ | −13.00 + 2.36Kₘ |
| −14.00 − 2.55Kₘ | −14.00 − 1.27Kₘ | −14.00 | −14.00 + 1.27Kₘ | −14.00 + 2.55Kₘ |
| −15.00 − 2.73Kₘ | −15.00 − 1.36Kₘ | −15.00 | −15.00 + 1.36Kₘ | −15.00 + 2.73Kₘ |
| −16.00 − 2.91Kₘ | −16.00 − 1.45Kₘ | −16.00 | −16.00 + 1.45Kₘ | −16.00 + 2.91Kₘ |

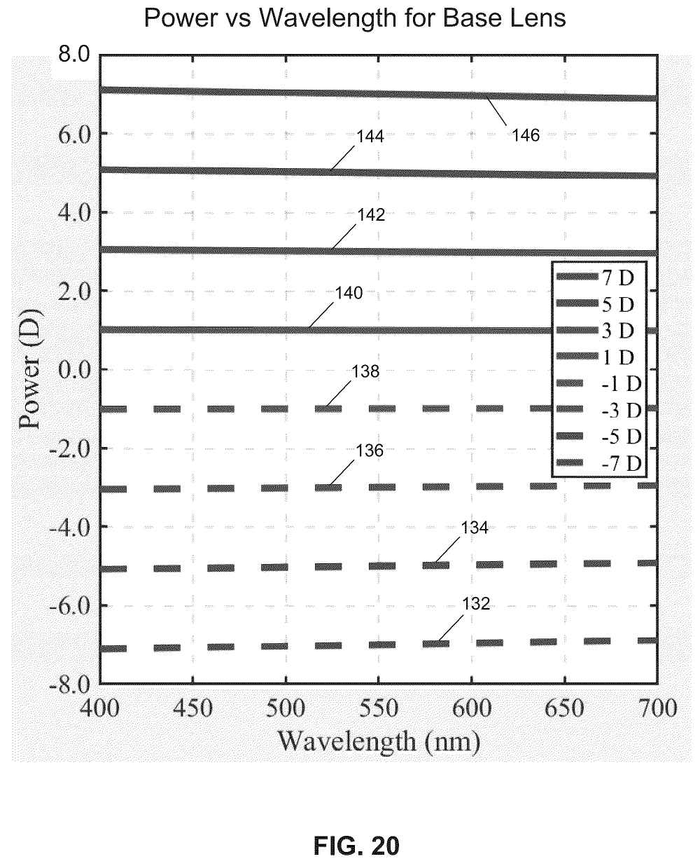

FIG. 23 illustrates a plot 66 of optical phase in waves (for a reference wavelength of 550 nm) versus radial coordinate for a phase-wrapped lens equivalent to the example lens of FIG. 22, using a phase-wrapping value of 1 wave. The phase-wrapped lens of FIG. 23 also generates a chromatic alteration.

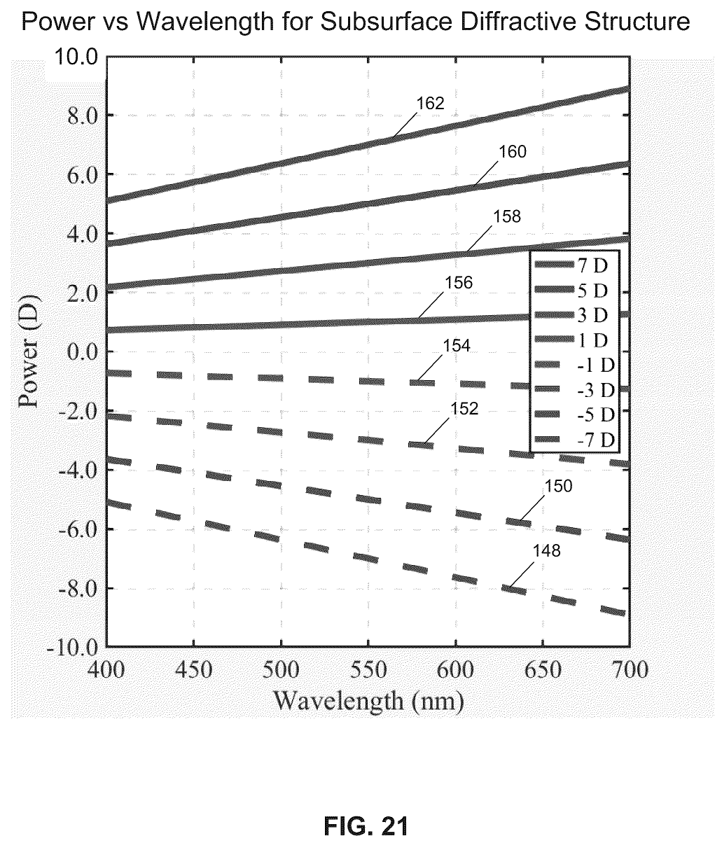

FIG. 24 shows an example chromatic alteration inducing lens 168 configured to alter or correct a chromatic aberration of an optical component or an optical system, in accordance with embodiments. The lens 168 has external surfaces 170, 172 shaped to alter a wavefront via refraction. The lens 168 also includes at least one subsurface diffractive optical structure 174 configured alter a wavefront via refraction and diffraction. The configurations of the external surfaces 170, 172 and the at least one subsurface diffractive optical structure 174 can be selected to reduce or fully correct a chromatic aberration of an optical component or an optical system as described herein. The configurations of the external surfaces 170, 172 and the at least one subsurface diffractive optical structure 174 can also be selected to provide a suitable wavefront correction to improve image quality. The chromatic alteration inducing lens 168 can be configured as any suitable lens such as any suitable ophthalmic lens (e.g., contact lens, spectacle lens, intraocular lens) and any suitable non-ophthalmic lens. Additionally, any suitable native lens (e.g., cornea, native crystalline lens) can be modified to be configured similar to the example chromatic alteration inducing lens 168 to reduce of fully correct a chromatic aberration of the corresponding eye and can be further configured to provide a suitable wavefront correction to improve image quality.

The chromatic alteration inducing lens 168 can employ any suitable configurations of the external surfaces 170, 172 and the at least one subsurface diffractive optical structure 174. For example, as described herein, the lens 168 can be configured to correct the chromatic aberrations of the example myopic eye of FIG. 16 by having the external surfaces 170, 172 shaped to provide a −6.12 diopters of optical power and the at least one subsurface diffractive optical structure 174 configured to provide a 3.12 diopters of optical power so that the lens 168 provides a net −3.0 diopters of optical power and achromatizes the example myopic eye of FIG. 16. As another example, as described herein, the lens 168 can be configured to provide a 4.0 diopter correction and achromatize an example hyperopic eye.

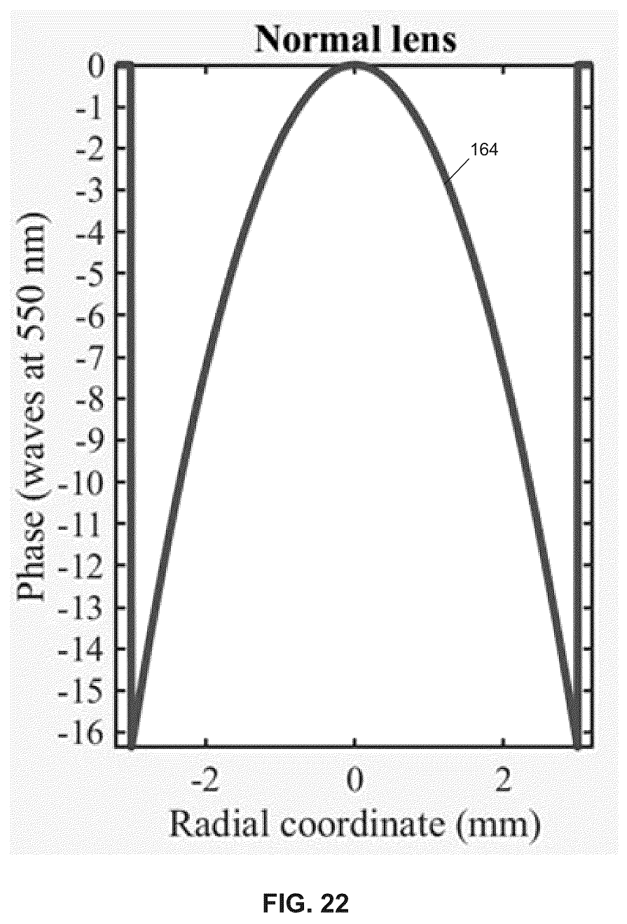

FIG. 25 show a simplified block diagram of a method 200 of configuring a lens for correcting a chromatic aberration, in accordance with embodiments. The method 200 can be configured to configure any suitable lens including, for example, the chromatic alteration inducing lens 168, which can be configured as any suitable ophthalmic lens and any suitable non-ophthalmic lens. Suitable ophthalmic lenses include, but are not limited to, natural lenses (e.g., corneas, crystalline lenses) and corrective lenses (e.g., contact lenses, intraocular lenses, spectacle lenses). The method of 200 can be practiced using any suitable ophthalmic systems including, but not limited to, the ophthalmic systems described herein.

In act 202, an optical correction at a design wavelength (e.g., at 550 nm) for an optical component or an optical system is determined. For example, an optical correction for an eye for improving image quality can be determined using any suitable approach. The determined optical correction at the design wavelength can be any optical correction that can be implemented via the combination of suitable shapes of the lens and suitable configurations of the at least one subsurface diffractive optical structures. For some optical components or optical systems, no correction at the design wavelength is desired and correction of chromatic aberrations is desired.

In act 204, the variation in optical power with wavelength (i.e., chromatic aberrations) for the corrected optical component or optical system (as corrected by the optical correction determined in act 202) is determined. Any suitable approach can be used to determine the variation in optical power with wavelength including, for example, the approaches described herein, calculation using known approaches, measuring, and/or employing known typical values such as the typical chromatic aberrations of an eye.

In act 206, an external shape for the lens is identified and the at least one subsurface diffractive optical structure for the lens is configured to provide the optical correction at the design wavelength and to alter or correct the chromatic aberrations of the corrected optical component or optical system. As can be seen by comparing the amount of contribution to chromatic aberration correction provided by the shape of the lens (as shown in FIG. 18) with the amount of contribution to chromatic alteration provided by the at least one subsurface diffractive optical structure (as shown in FIG. 19), the at least one subsurface diffractive optical structure will typically provide a majority of the chromatic aberration correction for an eye. For example, in the example configuration of the lens for correcting the chromatic aberrations shown in FIG. 16 for a myopic eye requiring −3.0 D of correction, the at least one subsurface diffractive optical structure (providing 3.12 diopter) provides about 90 percent of the chromatic aberration correction and the shape of the lens (providing −6.12 diopter) only provides about 10 percent of the chromatic aberration correction. Therefore, one approach for configuring the lens is to select a candidate configuration for the at least one subsurface diffractive optical structure that provides about 90 percent of the desired chromatic aberration correction, determine the optical power to be provided by the shape of the lens to produce the net optical correction for the lens at the design wavelength, determine the amount of chromatic aberration correction provided by the shape of the lens, and then determine the total amount of chromatic aberration correction provided by a lens having the candidate configuration of the at least one subsurface diffractive optical structure. If the total amount of chromatic aberration correction provided does not match the desired amount, iteration can be used to identify the next candidate configuration of the at least one subsurface diffractive optical structure based on whether more or less chromatic aberration correction is desired.

In act 208, the configuration of the at least one subsurface optical structure is defined including determining the associated changes to the refractive index in subsurface sub-volumes of the lens to be used to form the at least one subsurface optical structure. Any suitable approach can be used to define the configuration of the at least one subsurface optical structure. For example, in many embodiments, a wavefront map is defined that defines the wavefront changes to be induced by the at least one subsurface optical structure. The wavefront map can then be used to define the changes (including locations and amounts) in the refractive index of the lens for forming the at least one subsurface optical structure.

In act 210, the changes in the refractive index of the lens are induced to form the at least one subsurface optical structure within the lens. Any suitable approach can be used to induce the changes in the refractive index including, for example, any of the approaches described herein.

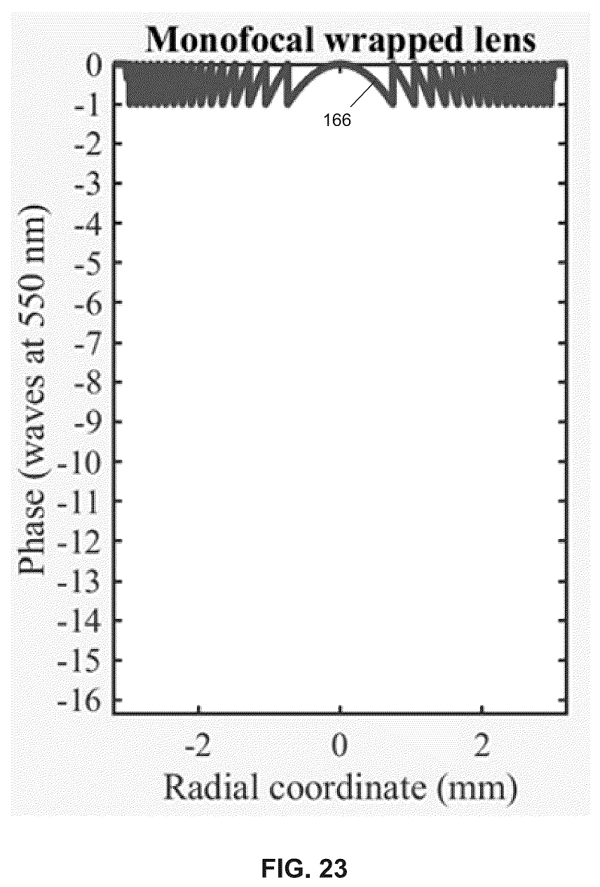

FIG. 26 shows a plot of Strehl Ratio for each of three different wavelengths (450, 550, and 650 nm) for the corrected and achromatized example myopic eye. FIG. 26 illustrates the effectiveness of utilizing the chromatic alteration inducing ophthalmic lens 68 of FIG. 24 to correct the chromatic aberrations generated by the human eye and the corrective ophthalmic lens (if any).

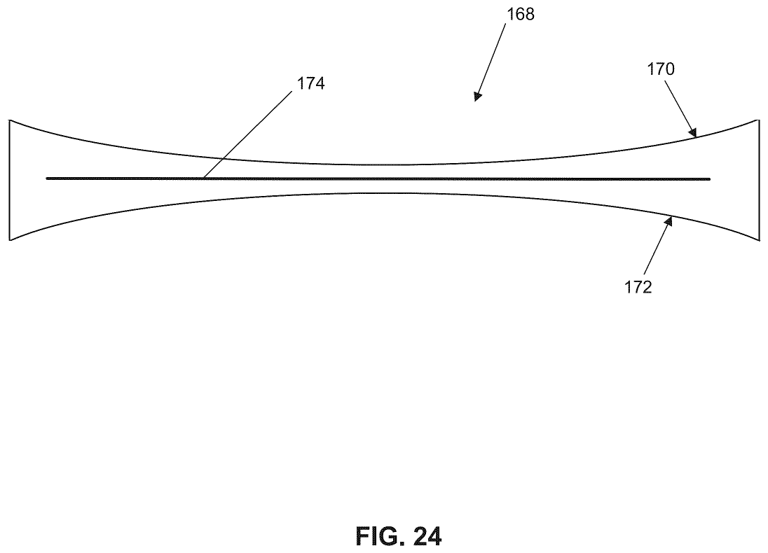

FIG. 27 shows another example chromatic alteration inducing ophthalmic lens 176 configured to correct a chromatic aberration of an optical component or an optical system, in accordance with embodiments. In the illustrated embodiment, the lens 176 is not shaped to provide any wavefront correction (except for maybe a plano wavefront correction). The lens 176 includes at least one subsurface diffractive optical structure 178 configured to alter a wavefront via refraction and diffraction. The at least one subsurface diffractive optical structure 178 can be configured (as described herein) to at least reduce and in some instances fully correct a chromatic aberration of an optical component or an optical system. The at least one subsurface diffractive optical structure 178 can also be configured to provide a suitable wavefront correction to improve image quality. The chromatic alteration inducing lens 176 can be configured as any suitable lens such as any suitable ophthalmic lens (e.g., contact lens, spectacle lens, intraocular lens) and any suitable non-ophthalmic lens. Additionally, the at least one subsurface diffractive optical structure can be formed within any suitable native lens (e.g., cornea, native crystalline lens).

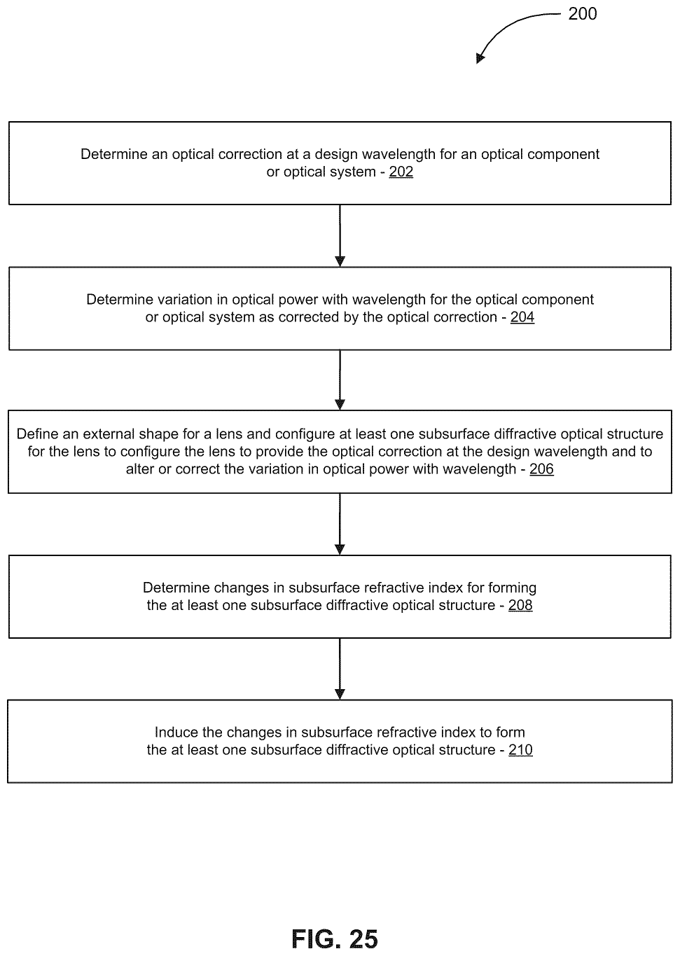

FIG. 28 illustrates a plot of optical phase in waves (for a reference wavelength of 550 nm) versus radial coordinate for a first example of the at least one subsurface diffractive optical structure 178 of the chromatic aberration correcting ophthalmic lens 176, in accordance with embodiments. The first example of the at least one subsurface diffractive optical structure 178 is configured to provide a reference wavefront correction that includes piston regions 126-0 through 126-17 of different constant whole number of optical phase in waves with respect to the reference wavelength (550 nm) and optical phase discontinuity regions 128-1 through 128-17. Each of the optical phase discontinuity regions 128-1 through 128-17 extends between and separates respective two immediately adjacent instances of the piston regions 126-0 through 126-17. The optical phase (waves) of the piston regions 126-0 through 126-17 also varies from 0.0 on the optical axis down to a negative 16.0 waves near the perimeter.

The first example of the at least one subsurface diffractive optical structure 176 provides a respective chromatic aberration correction, which provides aberration correction for wavelengths that differ from the reference wavelength. The plot of FIG. 28 shows changes in optical phase in waves for the reference wavelength (550 nm) for which the piston regions 126-0 through 126-17 provide change in optical phase in waves equal to different constant whole number optical phase in waves. As a result, the piston regions 126-0 through 126-17 are invisible to the reference wavelength (550 nm). In many embodiments, the at least one subsurface diffractive optical structure 178 can be implemented by inducing suitable refractive index subsurface changes in a lens using any suitable approach such as those described herein.

In a corresponding physical embodiment of the example at least one subsurface diffractive optical structure 178 of FIG. 28, each of the piston regions 126-0 through 126-17 are not invisible to wavelengths other than the reference wavelength. In a corresponding physical embodiment, the optical phase (waves) of each of the piston regions 126-0 and 126-17 varies as a function of wavelength. To illustrate, Table 5 lists changes in optical phase (waves) provided by each of the piston regions 126-0 through 126-17 for the reference wavelength (550 nm) and four other wavelengths (450, 500, 600, and 650 nm) calculated using the assumed linear relationship reflected in equation (1). Equation (1) shows that the optical phase (waves) provided by each of the piston regions 126-0 through 126-17 is larger (in magnitude) for the shorter example wavelengths (450, 500 nm) than for the reference wavelength (550 nm) and smaller (in magnitude) for the longer example wavelengths (600, 650 nm) than for the reference wavelength (550 nm) to reduce the chromatic aberration induced by the lens and/or the eye. Table 6 lists changes in optical phase (waves) provided by each of the piston regions 126-0 through 126-17 relative to the changes in optical phase (waves) provided by each of the piston regions 126-0 through 126-17 for the reference wavelength (550 nm).

TABLE 5
Changes in optical phase (waves) for different wavelengths provided
by each of the piston regions 126-0 through 126-17.

| Region | 450 nm | 500 nm | 550 nm | 600 nm | 650 nm |
|---|---|---|---|---|---|
| 126-0 | 0.00 | 0.00 | 0.00 | 0.00 | 0.00 |
| 126-1 | −1.0 − 0.18Kₘ | −1.0 − 0.09Kₘ | −1.00 | −1.0 + 0.09Kₘ | −1.0 + 0.18Kₘ |
| 126-2 | −2.0 − 0.36Kₘ | −2.0 − 0.18Kₘ | −2.00 | −2.0 + 0.18Kₘ | −2.0 + 0.36Kₘ |
| 126-3 | −3.0 − 0.55Kₘ | −3.0 − 0.27Kₘ | −3.00 | −3.0 + 0.27Kₘ | −3.0 + 0.55Kₘ |
| 126-4 | −4.0 − 0.73Kₘ | −4.0 − 0.36Kₘ | −4.00 | −4.0 + 0.36Kₘ | −4.0 + 0.73Kₘ |
| 126-5 | −5.0 − 0.91Kₘ | −5.0 − 0.45Kₘ | −5.00 | −5.0 + 0.45Kₘ | −5.0 + 0.91Kₘ |
| 126-6 | −6.0 − 1.09Kₘ | −6.0 − 0.55Kₘ | −6.00 | −6.0 + 0.55Kₘ | −6.0 + 1.09Kₘ |
| 126-7 | −7.0 − 1.27Kₘ | −7.0 − 0.64Kₘ | −7.00 | −7.0 + 0.64Kₘ | −7.0 + 1.27Kₘ |
| 126-8 | −8.0 − 1.45Kₘ | −8.0 − 0.73Kₘ | −8.00 | −8.0 + 0.73Kₘ | −8.0 + 1.45Kₘ |
| 126-9 | −9.0 − 1.64Kₘ | −9.0 − 0.82Kₘ | −9.00 | −9.0 + 0.82Kₘ | −9.0 + 1.64Kₘ |
| 126-10 | −10.0 − 1.82Kₘ | −10.0 − 0.91Kₘ | −10.00 | −10.0 + 0.91Kₘ | −10.0 + 1.82Kₘ |
| 126-11 | −11.0 − 2.00Kₘ | −11.0 − 1.00Kₘ | −11.00 | −11.0 + 1.00Kₘ | −11.0 + 2.00Kₘ |
| 126-12 | −12.0 − 2.18Kₘ | −12.0 − 1.09Kₘ | −12.00 | −12.0 + 1.09Kₘ | −12.0 + 2.18Kₘ |
| 126-13 | −13.0 − 2.36Kₘ | −13.0 − 1.18Kₘ | −13.00 | −13.0 + 1.18Kₘ | −13.0 + 2.36Kₘ |
| 126-14 | −14.0 − 2.55Kₘ | −14.0 − 1.27Kₘ | −14.00 | −14.0 + 1.27Kₘ | −14.0 + 2.55Kₘ |
| 126-15 | −15.0 − 2.73Kₘ | −15.0 − 1.36Kₘ | −15.00 | −15.0 + 1.36Kₘ | −15.0 + 2.73Kₘ |
| 126-16 | −16.0 − 2.91Kₘ | −16.0 − 1.45Kₘ | −16.00 | −16.0 + 1.45Kₘ | −16.0 + 2.91Kₘ |

TABLE 6
Changes in optical phase (waves) for different wavelengths provided
by each of the piston regions 126-0 through 126-17 relative to the
changes in optical phase (waves) provided by each of the piston regions
126-0 through 126-17 for the reference wavelength (550 nm).

| Region | 450 nm | 500 nm | 550 nm | 600 nm | 650 nm |
|---|---|---|---|---|---|
| 126-0 | 0.00 | 0.00 | 0.00 | 0.00 | 0.00 |
| 126-1 | −0.18Kₘ | −0.09Kₘ | 0.00 | 0.09Kₘ | 0.18Kₘ |
| 126-2 | −0.36Kₘ | −0.18Kₘ | 0.00 | 0.18Kₘ | 0.36Kₘ |
| 126-3 | −0.55Kₘ | −0.27Kₘ | 0.00 | 0.27Kₘ | 0.55Kₘ |
| 126-4 | −0.73Kₘ | −0.36Kₘ | 0.00 | 0.36Kₘ | 0.73Kₘ |
| 126-5 | −0.91Kₘ | −0.45Kₘ | 0.00 | 0.45Kₘ | 0.91Kₘ |
| 126-6 | −1.09Kₘ | −0.55Kₘ | 0.00 | 0.55Kₘ | 1.09Kₘ |
| 126-7 | −1.27Kₘ | −0.64Kₘ | 0.00 | 0.64Kₘ | 1.27Kₘ |
| 126-8 | −1.45Kₘ | −0.73Kₘ | 0.00 | 0.73Kₘ | 1.45Kₘ |
| 126-9 | −1.64Kₘ | −0.82Kₘ | 0.00 | 0.82Kₘ | 1.64Kₘ |
| 126-10 | −1.82Kₘ | −0.91Kₘ | 0.00 | 0.91Kₘ | 1.82Kₘ |
| 126-11 | −2.00Kₘ | −1.00Kₘ | 0.00 | 1.00Kₘ | 2.00Kₘ |
| 126-12 | −2.18Kₘ | −1.09Kₘ | 0.00 | 1.09Kₘ | 2.18Kₘ |
| 126-13 | −2.36Kₘ | −1.18Kₘ | 0.00 | 1.18Kₘ | 2.36Kₘ |
| 126-14 | −2.55Kₘ | −1.27Kₘ | 0.00 | 1.27Kₘ | 2.55Kₘ |
| 126-15 | −2.73Kₘ | −1.36Kₘ | 0.00 | 1.36Kₘ | 2.73Kₘ |
| 126-16 | −2.91Kₘ | −1.45Kₘ | 0.00 | 1.45Kₘ | 2.91Kₘ |

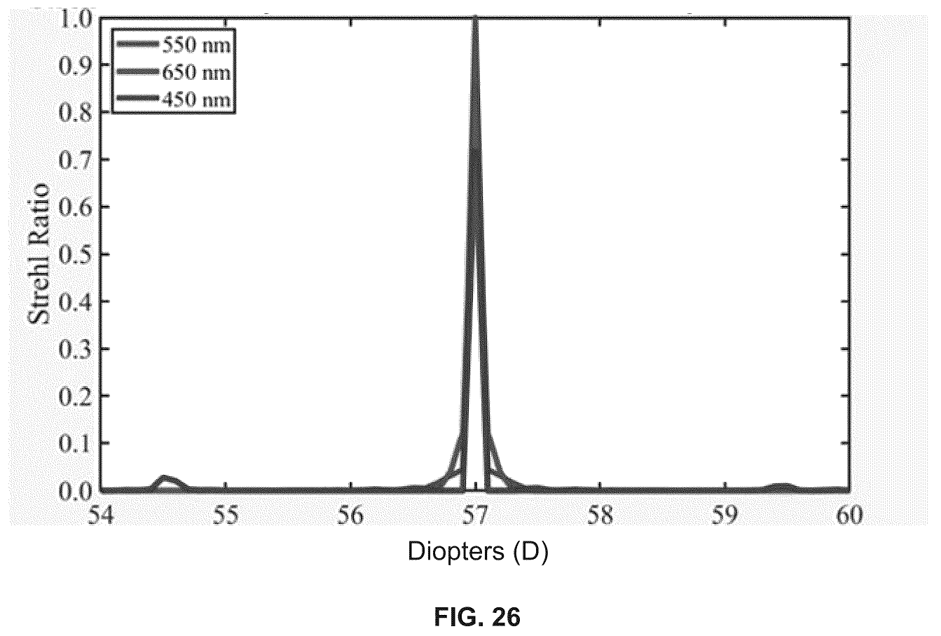

FIG. 29 illustrates a plot of optical phase (waves) for a reference wavelength (550 nm) versus radial coordinate for another example of the at least one subsurface diffractive optical structure 178, in accordance with embodiments. The example of the at least one subsurface diffractive optical structure 178 of FIG. 29 is configured similar to the first example of the at least one subsurface diffractive optical structure 178 of FIG. 29 and provides a reference wavefront correction that includes piston regions 130-0 through 130-60 of different constant whole number optical phase in waves with respect to the reference wavelength (550 nm) and optical phase discontinuity regions 132-1 through 132-60. Each of the optical phase discontinuity regions 132-1 through 132-60 extends between and separates respective two immediately adjacent instances of the piston regions 130-0 through 130-60.

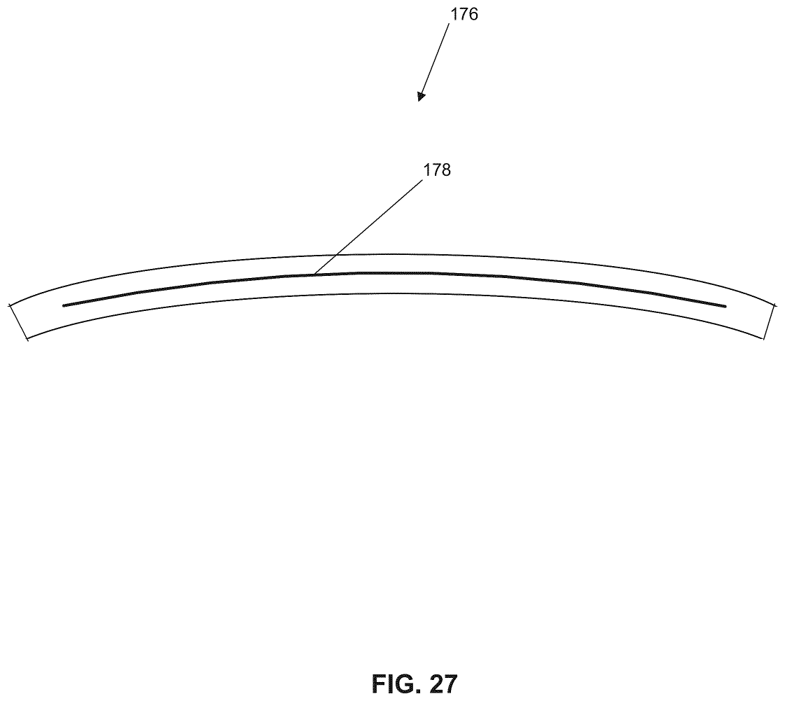

FIG. 30 show a simplified block diagram of a method 280 of configuring a lens for correcting a chromatic aberration, in accordance with embodiments. The method 280 can be configured to configure any suitable lens including, for example, the chromatic alteration inducing lens 176, which can be configured as any suitable ophthalmic lens and any suitable non-ophthalmic lens. Suitable ophthalmic lenses include, but are not limited to, natural lenses (e.g., corneas, crystalline lenses) and corrective lenses (e.g., contact lenses, intraocular lenses, spectacle lenses). The method of 280 can be practiced using any suitable ophthalmic systems including, but not limited to, the ophthalmic systems described herein.

In act 282, an optical correction at a design wavelength (e.g., at 550 nm) for an optical component or an optical system is determined. For example, an optical correction for an eye for improving image quality can be determined using any suitable approach. The determined optical correction at the design wavelength can be any optical correction that can be implemented via suitable configurations of the at least one subsurface diffractive optical structure 178 of the lens 176. For some optical components or optical systems, no correction at the design wavelength is desired and correction of chromatic aberrations is desired.

In act 284, the variation in optical power with wavelength (i.e., chromatic aberration) for the corrected optical component or optical system (as corrected by the optical correction determined in act 282) is determined. Any suitable approach can be used to determine the variation in optical power with wavelength including, for example, the approaches described herein, calculation using known approaches, measuring, and/or employing known typical values such as the typical chromatic aberration of an eye.

In act 286, the at least one subsurface diffractive optical structure 178 for the lens 176 is configured to provide the optical correction at the design wavelength and to alter or correct the chromatic aberrations of the corrected optical component or optical system. The at least one subsurface diffractive optical structure 178 can have any suitable configuration, such as any suitable configuration and/or combination of the subsurface diffractive optical structures described herein.

In act 288, the configuration of the at least one subsurface optical structure 178 is defined including determining the associated changes to the refractive index in subsurface sub-volumes of the lens to be used to form the at least one subsurface optical structure. Any suitable approach can be used to define the configuration of the at least one subsurface optical structure. For example, in many embodiments, a wavefront map is defined that defines the wavefront changes to be induced by the at least one subsurface optical structure 178. The wavefront map can then be used to define the changes (including locations and amounts) in the refractive index of the lens for forming the at least one subsurface optical structure 178.

In act 290, the changes in the refractive index of the lens are induced to form the at least one subsurface optical structure 178 within the lens 176. Any suitable approach can be used to induce the changes in the refractive index including, for example, any of the approaches described herein.

The chromatic alteration inducing lenses described herein can be employed in any suitable application, including, but not limited to, ophthalmic applications. In a human eye, the main refractive components are the cornea and the natural crystalline lens. Since the refractive index of cornea varies with wavelength, the cornea generates a corresponding chromatic aberration. Likewise, since the refractive index of the natural crystalline lens varies with wavelength, the natural crystalline lens generated a corresponding chromatic aberration.

The chromatic aberration correcting subsurface diffractive optical structures described herein can be configured to reduce and, in some cases, correct chromatic aberrations induced by any suitable optical component or system. The chromatic aberration correcting subsurface diffractive optical structures described herein can further be configured to also provide a wavefront correction for improving image quality.

The chromatic aberration correcting subsurface diffractive optical structures described herein can be defined using the following approach. First, the slope of the variation of combined optical power with wavelength of the optical system to be corrected can be calculated for use in configuring the subsurface chromatic aberration correcting optical structure to provide a suitable counteracting chromatic aberration. As illustrated in FIG. 18, the optical power of the myopic eye corrected with a diffractive monofocal contact lens varies from 58.75 (D) at 400 nm wavelength down to 55.21 (D) at 700 nm wavelength. The slope of the variation of combined optical power with wavelength for the example corrected myopic eye of FIG. 18 is calculated in equation (7) below.

$${( \frac{Δ P}{Δ λ} )}_{system} = ( \frac{55.21 D - 58.75 D}{700 nm - 400 nm} ) = - 0.0118 \frac{D}{nm} \qquad Equation ( 7 )$$

The slope of the variation of combined optical power with wavelength for the optical system composed of the myopic eye of FIG. 16 corrected with a diffractive monofocal contact lens of −3.0 D at the design wavelength of FIG. 17 can also be calculated using equation (8) set forth below.

$${( \frac{Δ P}{Δ λ} )}_{system} = {( \frac{Δ P}{Δ λ} )}_{eye} + {( \frac{Δ P}{Δ λ} )}_{Contact lens} \qquad Equation ( 8 )$$

$${( \frac{Δ P}{Δ λ} )}_{system} = ( {P}_{d , eye} ) ( \frac{1}{{v}_{eye}} ) ( \frac{1}{{λ}_{F} - {λ}_{c}} ) + ( \frac{{P}_{Central wavelength , Monofocal}}{{λ}_{central} )}$$

$$With :$$

$${λ}_{central} = 550 nm$$

$${λ}_{d} = 587.6 nm$$

$${λ}_{f} = 486.1 nm$$

$${λ}_{C} = 656.3 nm$$

$${v}_{eye} = Eye Abbe ' s number = 55.74$$

$${( \frac{Δ P}{Δ λ} )}_{system} = ( 60 D ) ( \frac{1}{55.74} ) ( \frac{1}{486.1 nm - 656.3 nm} ) + ( \frac{- 3 D}{550 nm} )$$

$${( \frac{Δ P}{Δ λ} )}_{system} = - 0.0118 \frac{D}{nm}$$

An equivalent power of a chromatic aberration correcting subsurface diffractive optical structure for achromatizing the optical system composed of the myopic eye of FIG. 16 corrected with a diffractive contact lens of −3.0 D at the design wavelength of FIG. 17 can be calculated in equation (9) below. This chromatic aberration correcting subsurface diffractive optical structure would be the result of subtracting the phase-wrapped optical structure (phase-wrapped at a value of 1 wave) with the dioptric power calculated in equation (9) below from the continuous phase optical structure with the dioptric power calculated in equation (9) below.

$$P = {( \frac{Δ P}{Δ λ} )}_{system} * {λ}_{central} \qquad Equation ( 9 )$$

$$P = {( - 0.0118 \frac{D}{nm} )}_{system} * ( 550 nm ) = - 6.4785 D$$

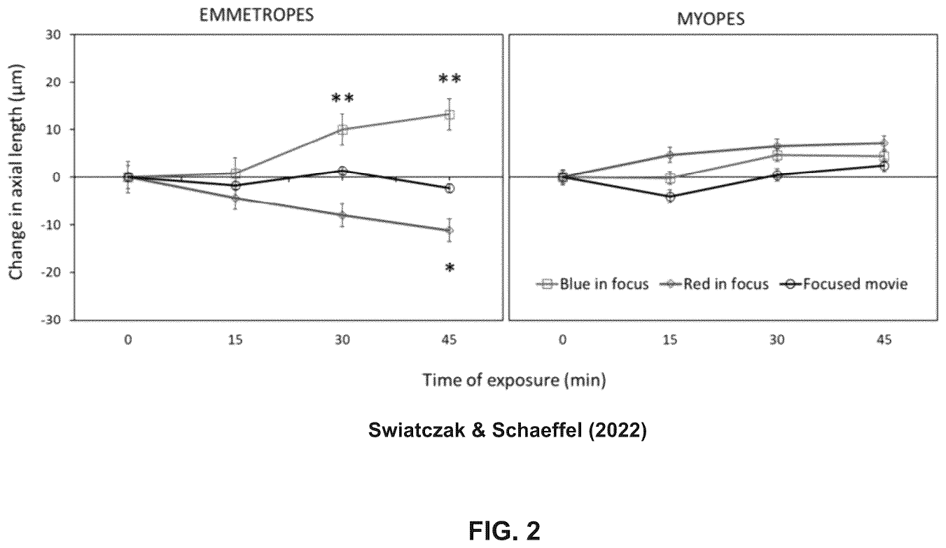

FIG. 29 illustrates a plot of optical phase in waves (for a reference wavelength (550 nm)) versus radial coordinate for a chromatic aberration correcting subsurface diffractive optical structure that achromatizes the optical system composed of the myopic eye of FIG. 2 corrected with a monofocal diffractive contact lens of −3.0 D at the design wavelength of FIG. 3.

### Subsurface Diffractive Optical Structures Configured for Partial Correction of Chromatic Aberrations

In a corresponding physical embodiment of the example chromatic aberration correcting subsurface diffractive optical structure of FIG. 28, each of the piston regions 126-0 through 126-17 can be implemented by a corresponding induced refractive index that provides the corresponding constant whole number of optical phase in waves with respect to a reference wavelength. In some lens materials, however, the maximum change in refractive index that may be induced in practice may be limited by practical considerations, such as expense and/or resulting optical quality. At least where the maximum change in refractive index that may be induced in practice is limited, a subsurface diffractive optical structure configured to partially correct the chromatic aberrations can be employed.

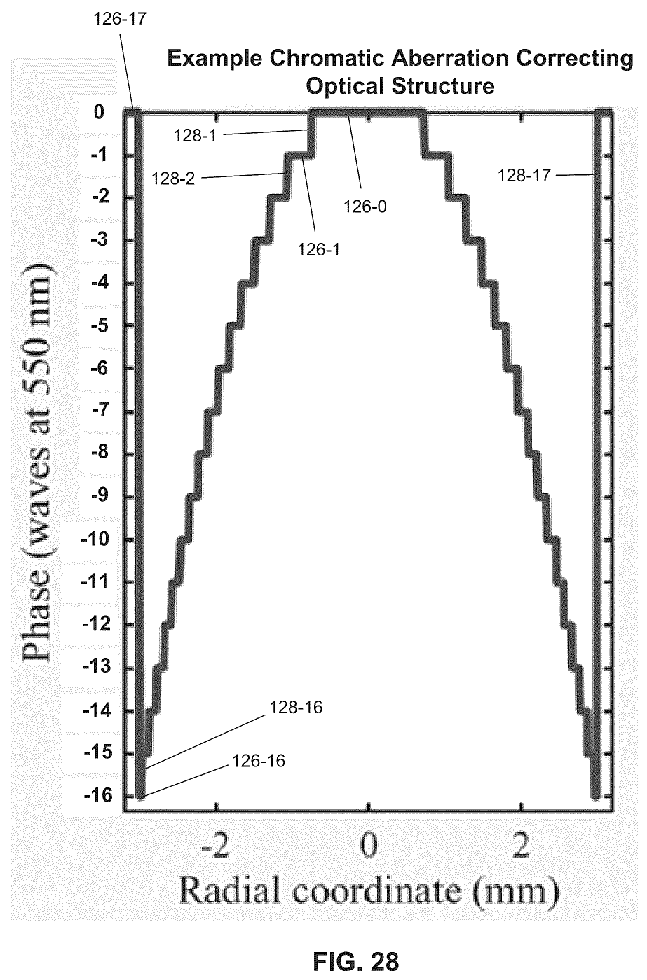

FIG. 31 shows another example chromatic alteration inducing lens 180 configured to reduce and, in some cases, correct a chromatic aberration of an optical component or an optical system, in accordance with embodiments. The lens 180 has external surfaces 170, 172 shaped to alter a wavefront via refraction. The lens 180 also includes at least one subsurface diffractive optical structure configured to alter a wavefront via refraction and diffraction. The configurations of the external surfaces 170, 172 and the at least one subsurface diffractive optical structure can be selected to reduce or fully correct a chromatic aberration of an optical component or an optical system as described herein. The configurations of the external surfaces 170, 172 and the at least one subsurface diffractive optical structure can also be selected to provide a suitable wavefront correction to improve image quality. The chromatic alteration inducing lens 180 can be configured as any suitable lens such as any suitable ophthalmic lens (e.g., contact lens, spectacle lens, intraocular lens) and any suitable non-ophthalmic lens. Additionally, any suitable native lens (e.g., cornea, native crystalline lens) can be modified to be configured similar to the example chromatic alteration inducing lens to reduce of fully correct a chromatic aberration of the corresponding eye and can be further configured to provide a suitable wavefront correction to improve image quality.

In the illustrated embodiment, the at least subsurface diffractive optical structure includes a first subsurface diffractive optical structure 182 configured to induce an optical power correction and a second subsurface diffractive optical structure 184 configured to provide a chromatic aberration correction without inducing an optical power correction. The first subsurface diffractive optical structure 182 can be configured the same as the subsurface diffractive optical structure 174 to provide a combined optical power correction and chromatic aberration correction. The second subsurface diffractive optical structure 184 can be configured the same as the subsurface diffractive optical structure 178 to provide a chromatic aberration correction without inducing an optical power correction. Each of the first subsurface diffractive optical structure 182, the second subsurface optical structure 184, and the exterior surfaces 170, 172 can be configured to provide a suitable combined optical correction combined with a suitable chromatic aberration correction for an eye, or any suitable optical component or system, using the approaches described herein. The first and second subsurface diffractive optical structures 182, 184 can be combined into a single equivalent subsurface diffractive optical. The first and second subsurface diffractive optical structures 182, 184 can also be implemented in 3, 4, 5, 6, or more subsurface diffractive optical structures, which in combined effect induce the same combined wavefront correction induced by the combination of the first and second subsurface diffractive optical structures 182, 184.

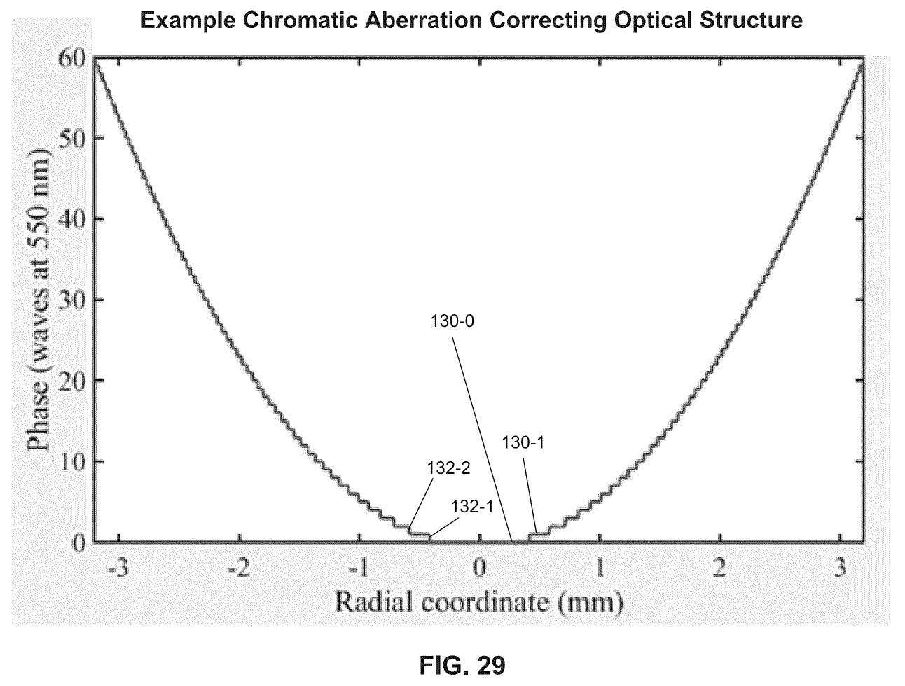

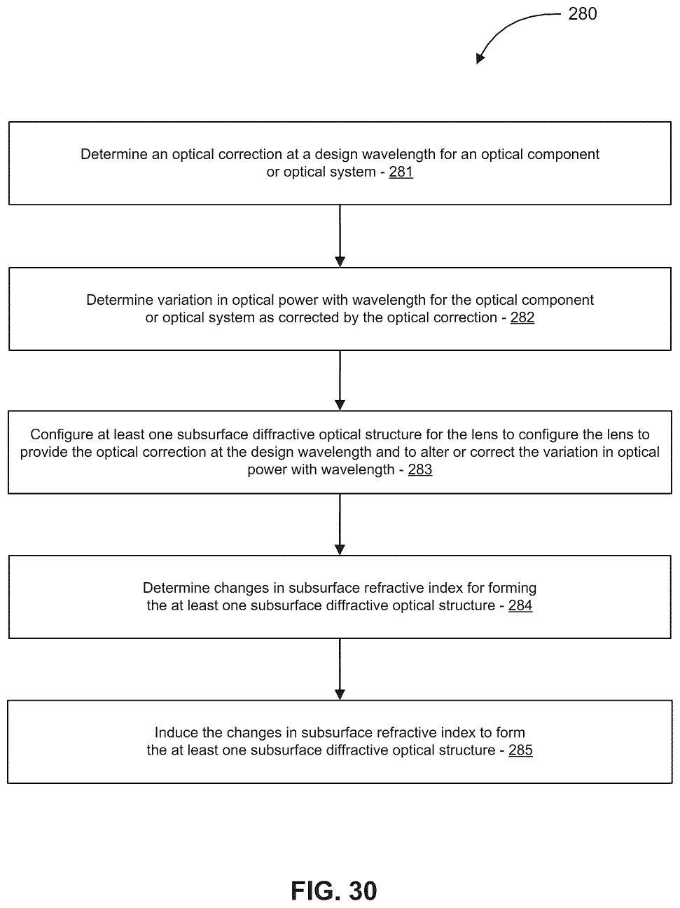

Employing the second subsurface diffractive optical structure 184 (which is configured to contribute to aberration correction without inducing an optical power correction) can be used to help deal with some potential configurational constraints. For example, for contact lenses, there may be limits on the maximum concavity of the external surfaces 170, 172 that can be employed thereby limiting the maximum amount of negative optical power that can be induced via the shape of the external surfaces 170, 174. The second subsurface diffractive optical structure 184 can be used to provide a portion of the desired chromatic aberration correction, thereby reducing the amount of concavity of the external surfaces 170, 172. On the other hand, since the amount of chromatic aberration correction that can be provided by the first subsurface diffractive optical structure 184 may be limited by the maximum amount of waves that can be employed to form the first subsurface diffractive optical structure 184, the combination of the external surfaces 170, 172 and the second subsurface diffractive optical structure can be employed to provide a portion of the desired chromatic aberration correction, thereby reducing the maximum number of waves required to form the first subsurface diffractive optical structure 184. The second subsurface diffractive optical structure 184 can also be used to enable use of a limited number of lens body configurations, for example, with exterior surfaces 170, 174 shaped to provide a limited selection of induced optical powers (e.g. −1.0 diopter, −2.0 diopter, −3.0 diopter) and still accommodate customization of the amount of chromatic aberration correction required by the lens by employing the second subsurface diffractive optical structure 184 to provide a portion of the desired total chromatic aberration correction. FIG. 32 shows plots of the maximum diameter of a chromatic aberration correcting subsurface diffractive optical structure that can be generated with a maximum phase available for several examples of equivalent powers of the chromatic aberration correcting optical structure calculated in equation (9) above. FIG. 33 shows a plot of the maximum phase necessary to create a 6 mm diameter chromatic aberration correcting subsurface diffractive optical structure as a function of the equivalent optical power in diopters of the chromatic aberration correcting optical structure calculated in equation (9) above.

The chromatic-aberration-modifying-optical-structures described herein can be employed in any suitable lens used in any suitable application, including, but not limited to, ophthalmic applications. In a human eye, the main refractive components are the cornea and the natural crystalline lens. Since the refractive index of cornea varies with wavelength, the cornea generates a corresponding chromatic aberration. Likewise, since the refractive index of the natural crystalline lens varies with wavelength, the natural crystalline lens generated a corresponding chromatic aberration. The chromatic-aberration-modifying-optical-structures described herein can be configured to correct both the chromatic aberration generated by the eye and the chromatic aberration generated by an ophthalmic lens used to provide an optical power correction for the eye.

### LCA Alteration in the Peripheral Retina

The LCA in the peripheral retina can be modified differently from the LCA in the central retina. As one non-limiting example, the LCA in the central retina can be partially or fully corrected and the LCA in the peripheral retina can be increased or over-corrected.

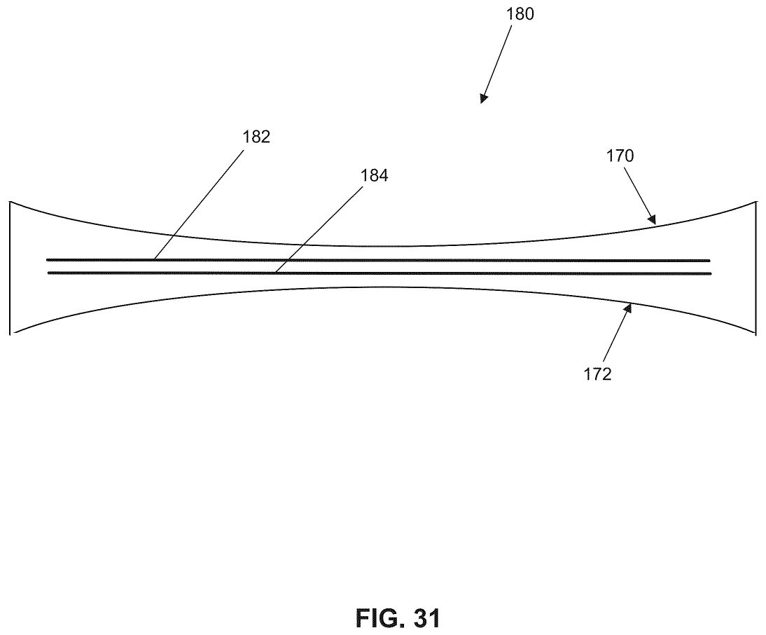

FIG. 34 shows plots of optical quality for different wavelengths (405 nm, 455 nm, 505 nm, 555 nm, 605 nm, 655 nm, 695 nm) as a function of defocus for central-vision corrected myopes, central-vision corrected emmetropes, and central-vision corrected hyperopes for the foveal retina (0 degree) and the peripheral retina (at 10 degree, 20 degree, and 30 degree). The optical quality plots for the different wavelengths evidence a substantial degree of LCA in both the foveal retina and the peripheral retina. The LCA altering ophthalmic lenses and approaches described herein can be used to alter the LCA of an eye to selectively tailor the light incident on the foveal retina and/or the peripheral retina to provide a stimulus to the eye to inhibit myopia progression by inhibiting axial growth of the eye or reducing the axial length of the eye. Corresponding plots of optical quality for the foveal retina and the peripheral retina for different wavelengths as a function of defocus can be generated for any particular eye via optical measurements using existing approaches. An ophthalmic lens can be configured to provide suitable chromatic alterations for on-axis light incident on the foveal retina and on the peripheral retina to provide myopia inhibiting stimuli via the wavelength of light focused on the foveal retina and the peripheral retina using the approaches described herein.

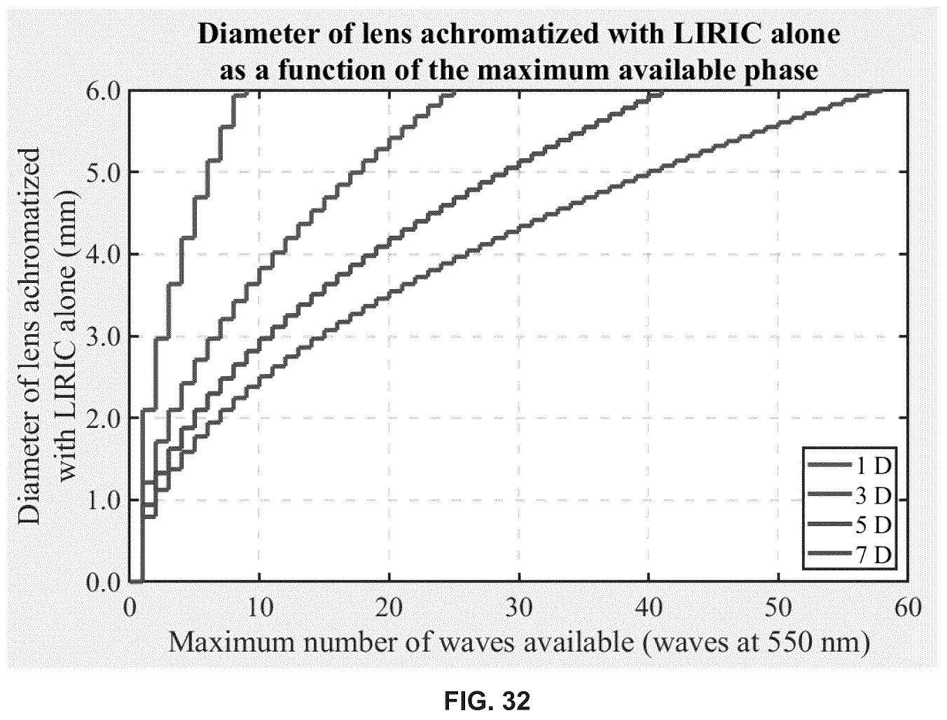

FIG. 35 shows plots of optical quality for emmetropes at different pupil diameters as a function of defocus for a 555 nm wavelength. As evidenced by the optical quality plots of FIG. 35, the extent of variation in optical quality as a function of defocus reduces with reducing pupil diameter. For the smaller pupil diameters, the light passing through the pupil passes through a more limited region of the native crystalline lens The change in through-focus optical quality with pupil size can be accounted for in configuring an ophthalmic lens by evaluating ophthalmic lens configuration(s) at pupil sizes of interest.

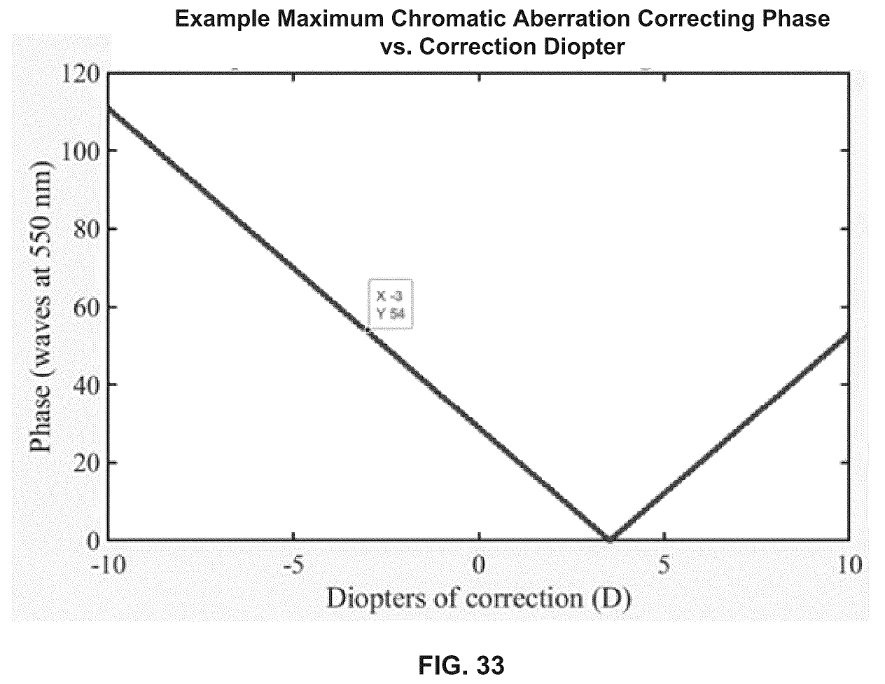

FIG. 36 shows a zonal diagram for a chromatic alteration inducing ophthalmic lens 286, in accordance with embodiments. In the illustrated embodiment, the chromatic alteration inducing ophthalmic lens 286 includes a central zone 287 and an annular zone 288. The central zone 287 can be configured to provide any suitable combination of vision correction (for a central design wavelength) and/or a chromatic alteration (e.g., for image quality improvement, for myopia progression control) for on-axis light incident on the foveal retina. Likewise, the annular zone 288 can be configured to provide any suitable combination of vision correction (for a central design wavelength) and/or a chromatic alteration (e.g., for image quality improvement, for myopia progression control) for on-axis light incident on the peripheral retina. The annular zone 288 can be subdivided into any suitable number of concentric annular zones for corresponding zones of the peripheral retina. In some embodiments, the ophthalmic lens 286 has an exterior shape configured to provide an exterior shape refractive wavefront alteration. In some embodiments, the ophthalmic lens has constant thickness.

Using the approaches described herein, the ophthalmic lens 286 can be configured to inhibit progression of myopia. The annular zone 288 can include an annular zone subsurface optical structure. The ophthalmic lens 286 can be formed from a transparent material having a lens material refractive index. The annular zone subsurface optical structure can include refractive indices that differ from the lens material refractive index to provide an annular zone chromatic alteration for light incident on the peripheral retina to reduce a rate of axial growth of the eye or decrease an axial length of the eye. Using the approaches described herein, the annular zone chromatic alteration can be produced via the annular zone subsurface optical structure inducing a diffractive wavefront, which has a negative Abbe number.

In many embodiments, the annular zone chromatic alteration decreases a focal length of a red-light wavelength and increases the focal length of a blue-light wavelength. Any suitable magnitude of the annular zone chromatic alteration can be used. For example, the annular zone subsurface optical structure is configured to provide at least a 3.0 diopter diffractive wave front that provides the annular zone chromatic alteration. The annular zone subsurface optical structure can be configured to provide at least a 6.0 diopter diffractive wave front that provides the annular zone chromatic alteration. The annular zone subsurface optical structure can be configured to provide at least a 9.0 diopter diffractive wave front that provides the annular zone chromatic alteration.

In some embodiments, the annular zone has an exterior shape configured to provide an annular zone exterior shape refractive wavefront alteration. The annular zone chromatic alteration and the annular zone exterior shape refractive wavefront alteration can be configured to jointly provide a combined wavefront alteration with 0 diopter of optical power. The annular zone chromatic alteration and the annular zone exterior shape refractive wavefront alteration can be configured to jointly provide a positive diopter combined wavefront alteration. The annular zone chromatic alteration and the annular zone exterior shape refractive wavefront alteration can be configured to jointly provide a negative diopter combined wavefront alteration. The annular zone can have an exterior shape configured to provide a zero diopter annular zone refractive wavefront alteration.

Using the approaches described herein, the central zone 287 can include a central zone subsurface optical structure comprising refractive indices that differ from the lens material refractive index to provide a central zone chromatic alteration for light incident on the foveal retina to reduce a rate of axial growth of the eye or decrease an axial length of the eye. In many embodiments, the central zone chromatic alteration decreases a focal length of a red-light wavelength and increases the focal length of a blue-light wavelength. Any suitable magnitude of the central zone chromatic alteration can be used. For example, the central zone subsurface optical structure can be configured to provide at least a 3.0 diopter diffractive wave front that provides the central zone chromatic alteration. The central zone subsurface optical structure can be configured to provide at least a 6.0 diopter diffractive wave front that provides the central zone chromatic alteration. The central zone subsurface optical structure can be configured to provide at least a 9.0 diopter diffractive wave front that provides the central zone chromatic alteration. In some embodiments, the central zone does not include a subsurface optical that includes refractive indices that differ from the lens material refractive index.

Using the approaches described herein, the central zone 287 can include an exterior shape configured to provide a central zone exterior shape refractive wavefront alteration. The central zone chromatic alteration and the central zone exterior shape refractive wavefront alteration can be configured to jointly provide a combined wavefront alteration that provides zero diopter of optical power. The central zone chromatic alteration and the central zone exterior shape refractive wavefront alteration can be configured to jointly provide a positive diopter combined wavefront alteration. The central zone chromatic alteration and the central zone exterior shape refractive wavefront alteration can be configured to jointly provide a negative diopter combined wavefront alteration. The ophthalmic lens 286 can have a constant thickness. The ophthalmic lens 286 can have an exterior shape with a varying thickness configured to provide an exterior shape refractive wavefront alteration.

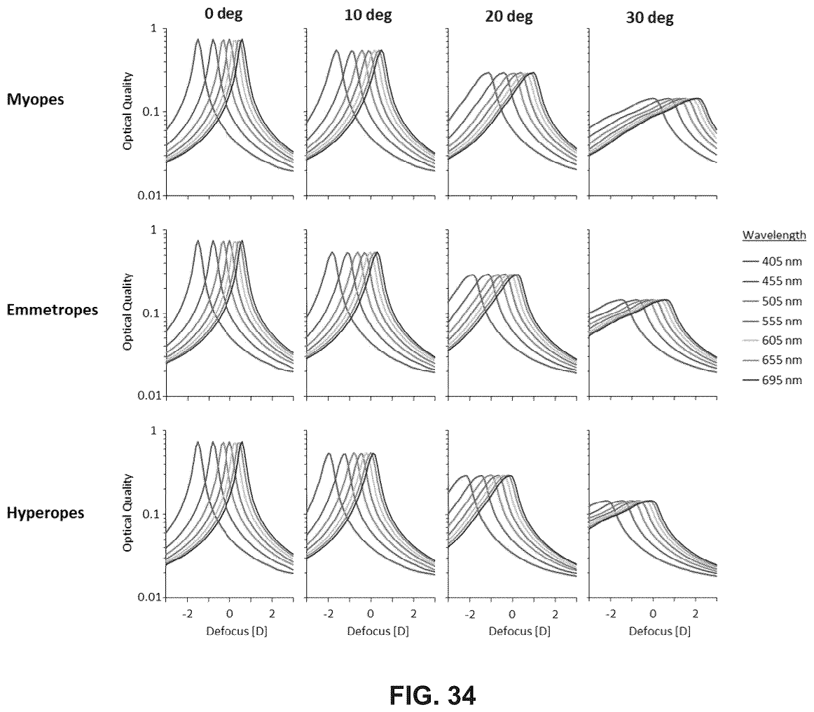

FIG. 37 show a simplified block diagram of a method 290 that can be used to produce the ophthalmic lens 286, in accordance with embodiments. The method includes: (a) determining a chromatic alteration for light passing through an annular zone and/or a central zone of the ophthalmic lens for light incident on the peripheral and/or foveal retina for reducing a rate of axial growth of the eye or decreasing an axial length of the eye (act 291), (b) determining an annular zone subsurface optical structure for the ophthalmic lens for inducing the chromatic alteration (act 292), (c) determining changes in subsurface refractive index for sub-volumes of the ophthalmic lens for forming the subsurface optical structure within the ophthalmic lens (act 293), and (d) inducing the changes in subsurface refractive index in the sub-volumes of the ophthalmic lens to form the subsurface optical structure within the ophthalmic lens (act 294). Any suitable approaches can be used to accomplish the acts of the method 290, such as those described herein.

### Ophthalmic Lens Kits for Treatment of Myopia

In some embodiments, kits of LCA modifying lenses can be configured for sequential use to slow, arrest, and then reverse Myopia. In such kits, the LCA modifying lenses can be configured using the approaches described herein to be sequentially worn to provide a progressively varying LCA modification for slowing, arresting, and then reversing Myopia.

### Tailoring of LCA in Ophthalmic Lenses

The LCA modifying ophthalmic lenses and diffractive subsurface optical structures can be configured for use in any suitable ophthalmic application. For example, the LCA modifying ophthalmic lenses with diffractive subsurface optical structures can be configured for use in treating myopia, hyperopia, astigmatism, and/or presbyopia to improve the resulting image quality.

### Laser and Optical Systems for Forming Subsurface Optical Elements

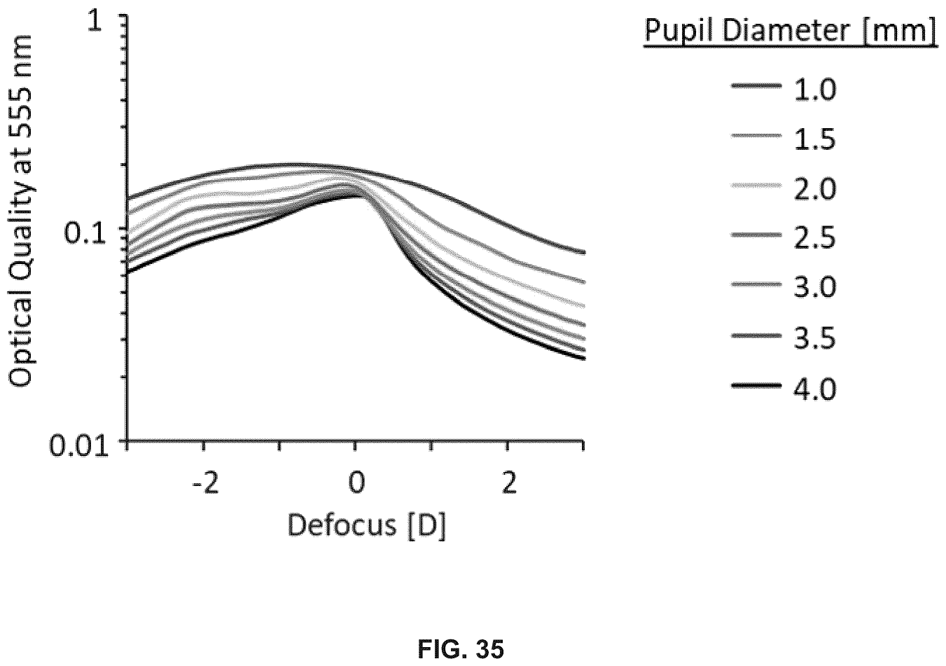

FIG. 38 is a schematic representation of the laser and optical system 300 that can be used to modify an ophthalmic lens to be configured to create high-quality vision for the patient and/or inhibit progression of myopia, in accordance with embodiments. The system 300 includes a laser source that includes a Kerr-lens mode-locked Ti:Sapphire laser 312 (Kapteyn-Mumane Labs, Boulder, Colo.) pumped by 4 W of a frequency-doubled Nd: YVO4 laser 314. The laser generates pulses of 300 mW average power, 30 fs pulse width, and 93 MHz repetition rate at wavelength of 800 nm. Because there is a reflective power loss from the mirrors and prisms in the optical path, and in particular, from the power loss of the objective 320, the measured average laser power at the objective focus on the material is about 120 mW, which indicates the pulse energy for the femtosecond laser is about 1. 3 nJ.

Due to the limited laser pulse energy at the objective focus, the pulse width can be preserved so that the pulse peak power is strong enough to exceed the nonlinear absorption threshold of the ophthalmic lens. Because a large amount of glass inside the focusing objective significantly increases the pulse width due to the positive dispersion inside of the glass, an extra-cavity, compensation scheme can be used to provide the negative dispersion that compensates for the positive dispersion introduced by the focusing objective. Two SF10 prisms 324 and 328 and one ending mirror 332 form a two-pass one-prism-pair configuration. A 37. 5 cm separation distance between the prisms can be used to compensate the dispersion of the microscope objective and other optics within the optical path.

A collinear autocorrelator 340 using third-order harmonic generation is used to measure the pulse width at the objective focus. Both 2nd and 3rd harmonic generation have been used in autocorrelation measurements for low NA or high NA objectives. Third order surface harmonic generation (THG) autocorrelation was selected to characterize the pulse width at the focus of the high-numerical-aperture objectives because of its simplicity, high signal to noise ratio and sign of material dispersion that second harmonic generation (SHG) crystals usually introduce. The THG signal is generated at the interface of air and an ordinary cover slip 342 (Corning No. 0211 Zinc Titania glass) and measured with a photomultiplier 344 and a lock-in amplifier 346. After using a set of different high-numerical-aperture objectives and carefully adjusting the separation distance between the two prisms and the amount of glass inserted, a transform-limited 27-fs duration pulse was selected. The pulse is focused by a 60X 0.70NA Olympus LUCPlanFLN long-working-distance objective 348.

Because the laser beam will spatially diverge after it comes out of the laser cavity, a concave mirror pair 350 and 352 is added into the optical path in order to adjust the dimension of the laser beam so that the laser beam can optimally fills the objective aperture. A 3D 100 nm resolution DC servo motor stage 354 (Newport VP-25XA linear stage) and a 2D 0.7 nm resolution piezo nanopositioning stage (P1 P-622. 2CD piezo stage) are controlled and programmed by a computer 356 as a scanning platform to support and locate an ophthalmic lens 357. The servo stages have a DC servomotor so they can move smoothly between adjacent steps. An optical shutter controlled by the computer with 1 ms time resolution is installed in the system to precisely control the laser exposure time. With customized computer programs, the optical shutter could be operated with the scanning stages to form the subsurface optical elements in the ophthalmic lens 357 with different scanning speed at different position and depth and different laser exposure time. In addition, a CCD camera 358 along with a monitor 362 is used beside the objective 320 to monitor the process in real time. The system 300 can be used to modify the refractive index of an ophthalmic lens to form subsurface optical elements that are configured to create high-quality vision for the patient and/or provide a myopia progression inhibiting optical correction for each of one or more locations in the peripheral retina.

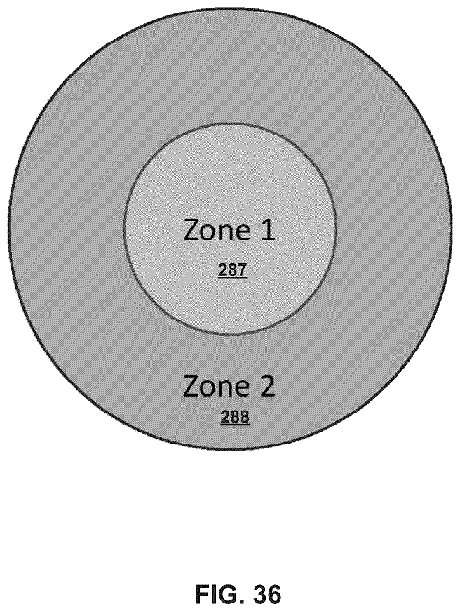

FIG. 39 is a simplified schematic illustration of another system 430 used for forming one or more subsurface optical structures within an ophthalmic lens 410, in accordance with embodiments. The system 430 includes a laser beam source 432, a laser beam intensity control assembly 434, a laser beam pulse control assembly 436, a scanning/interface assembly 438, and a control unit 440.

The laser beam source 432 generates and emits a laser beam 446 having a suitable wavelength for inducing refractive index changes in target sub-volumes of the ophthalmic lens 410. In examples described herein, the laser beam 446 has a 1035 nm wavelength. The laser beam 446, however, can have any suitable wavelength (e.g., in a range from 400 to 1100 nm) effective in inducing refractive index changes in the target sub-volumes of the ophthalmic lens 410.

The laser beam intensity control assembly 434 is controllable to selectively vary intensity of the laser beam 446 to produce a selected intensity laser beam 48 output to the laser beam pulse control assembly 436. The laser beam intensity control assembly 434 can have any suitable configuration, including any suitable existing configuration, to control the intensity of the resulting laser beam 448. In many instances, the laser beam intensity control assembly utilizes an acousto-optic modulator.

The laser beam pulse control assembly 436 is controllable to generate collimated laser beam pulses 450 having suitable duration, intensity, size, and spatial profile for inducing refractive index changes in the target sub-volumes of the ophthalmic lens 410. The laser beam pulse control assembly 436 can have any suitable configuration, including any suitable existing configuration, to control the duration of the resulting laser beam pulses 450.

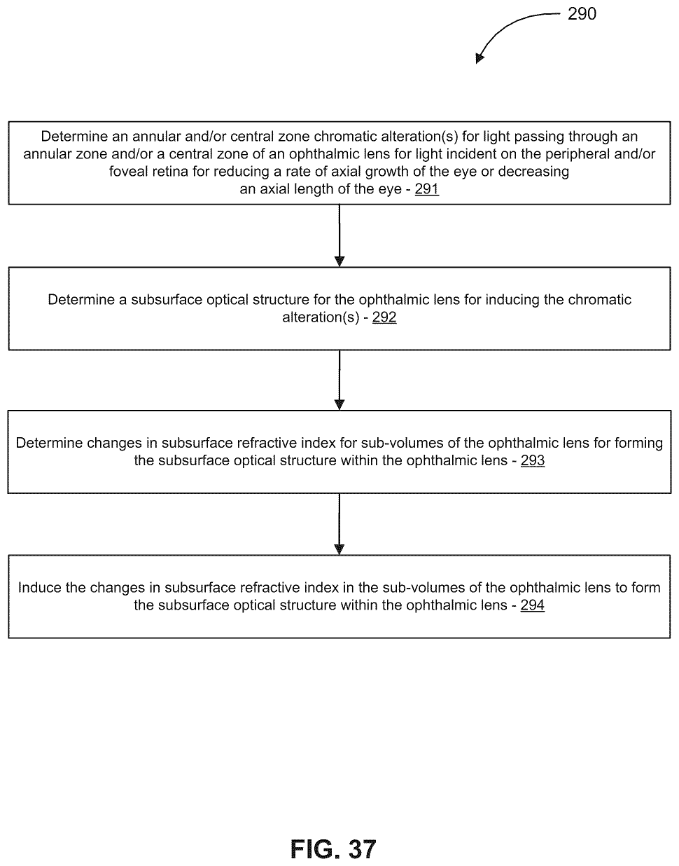

The scanning/interface assembly 438 is controllable to selectively scan the laser beam pulses 450 to produce XYZ scanned laser pulses 474. The scanning/interface assembly 438 can have any suitable configuration, including any suitable existing configuration (for example, the configuration illustrated in FIG. 40) to produce the XYZ scanned laser pulses 474. The scanning/interface assembly 438 receives the laser beam pulses 450 and outputs the XYZ scanned laser pulses 474 in a manner that minimizes vignetting. The scanning/interface assembly 438 can be controlled to selectively scan each of the laser beam pulses 450 to generate XYZ scanned laser pulses 474 focused onto targeted sub-volumes of the ophthalmic lens 410 to induce the respective refractive index changes in targeted sub-volumes so as to form the one or more subsurface optical structures within an ophthalmic lens 410. In many embodiments, the scanning/interface assembly 438 is configured to restrain the position of the ophthalmic lens 410 to a suitable degree to suitably control the location of the targeted sub-volumes of the ophthalmic lens 410 relative to the scanning/interface assembly 438. In many embodiments, such as the embodiment illustrated in FIG. 40, the scanning/interface assembly 438 includes a motorized Z-stage that is controlled to selectively control the depth within the ophthalmic lens 410 to which each of the XYZ scanned laser pulses 474 is focused.

The control unit 440 is operatively coupled with each of the laser beam source 432, the laser beam intensity control assembly 434, the laser beam pulse control assembly 436, and the scanning/interface assembly 438. The control unit 440 provides coordinated control of each of the laser beam source 432, the laser beam intensity control assembly 434, the laser beam pulse control assembly 436, and the scanning/interface assembly 438 so that each of the XYZ scanned laser pulses 474 have a selected intensity and duration and are focused onto a respective selected sub-volume of the ophthalmic lens 410 to form the one or more subsurface optical structures within an ophthalmic lens 410. The control unit 440 can have any suitable configuration. For example, in some embodiments, the control unit 440 comprises one or more processors and a tangible memory device storing instructions executable by the one or more processors to cause the control unit 440 to control and coordinate operation of the of the laser beam source 432, the laser beam intensity control assembly 434, the laser beam pulse control assembly 436, and the scanning/interface assembly 438 to produce the XYZ scanned laser pulses 474, each of which is synchronized with the spatial position of the sub-volume optical structure.

FIG. 40 is a simplified schematic illustration of an embodiment of the scanning/interface assembly 438. In the illustrated embodiment, the scanning/interface assembly 438 includes an XY galvo scanning unit 442, a relay optical assembly 444, a Z stage 466, an XY stage 468, a focusing objective lens 470, and a patient interface/ophthalmic lens holder 472. The XY galvo scanning unit 438 includes XY galvo scan mirrors 454, 456. The relay optical assembly 440 includes concave mirrors 460, 461 and plane mirrors 462, 464.

The XY galvo scanning unit 442 receives the laser pulses 450 (e.g., 1035 nm wavelength collimated laser pulses) from the laser beam pulse control assembly 436. In the illustrated embodiment, the XY galvo scanning unit 442 includes a motorized X-direction scan mirror 454 and a motorized Y-direction scan mirror 456. The X-direction scan mirror 454 is controlled to selectively vary orientation of the X-direction scan mirror 454 to vary direction/position of XY scanned laser pulses 458 in an X-direction transverse to direction of propagation of the XY scanned laser pulses 458. The Y-direction scan mirror 456 is controlled to selectively vary orientation of the Y-direction scan mirror 456 to vary direction/position of the XY scanned laser pulses 458 in a Y-direction transverse to direction of propagation of the XY scanned laser pulses 458. In many embodiments, the Y-direction is substantially perpendicular to the X-direction.

The relay optical assembly 440 receives the XY scanned laser pulses 458 from the XY galvo scanning unit 442 and transfers the XY scanned laser pulses 458 to Z stage 466 in a manner that minimizes vignetting. Concave mirror 460 reflects each of the XY scanned laser pulse 458 to produce a converging laser pulses incident on plane mirror 462. Plane mirror 462 reflects the converging XY scanned laser pulse 458 towards plane mirror 464. Between the plane mirror 462 and the plane mirror 464, the XY scanned laser pulse 458 transitions from being convergent to being divergent. The divergent laser pulse 458 is reflected by plane mirror 464 onto concave mirror 461. Concave mirror 461 reflects the laser pulse 458 to produce a collimated laser pulse that is directed to the Z stage 466.

The Z stage 466 receives the XY scanned laser pulses 458 from the relay optical assembly 442. In the illustrated embodiment, the Z stage 466 and the XY stage 468 are coupled to the focusing objective lens 470 and controlled to selectively position the focusing objective lens 470 relative to the ophthalmic lens 410 for each of the XY scanned laser pulses 474 so as to focus the XYZ scanned laser pulse 474 onto a respective targeted sub-volume of the ophthalmic lens 410. The Z stage 466 is controlled to selectively control the depth within the ophthalmic lens 410 to which the laser pulse is focused (i.e., the depth of the sub-surface volume of the ophthalmic lens 410 on which the laser pulse is focused to induce a change in refractive index of the targeted sub-surface volume). The XY stage 468 is controlled in conjunction with control of the XY galvo scanning unit 442 so that the focusing objective lens 470 is suitably positioned for the respective transverse position of each of the XY scanned laser pulses 458 received by the Z stage 466. The focusing objective lens 470 converges the laser pulse onto the targeted sub-surface volume of the lens 410. The patient interface/ophthalmic lens holder 472 restrains the ophthalmic lens 410 in a fixed position to support scanning of the laser pulses 474 by the scanning/interface assembly 438 to form the subsurface optical structures within the ophthalmic lens 410.

### Defining Subsurface Optical Elements for a Specified Optical Correction

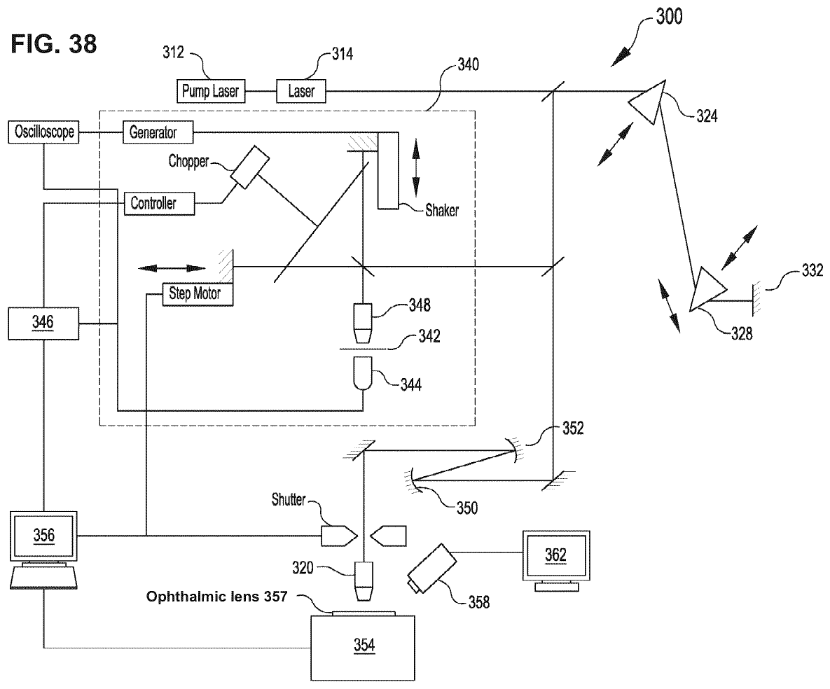

FIG. 41 through FIG. 48 illustrate a process that can be used to define subsurface optical elements for a specified optical correction. While an optical correction configured to create high-quality vision for the patient and/or inhibit progression of myopia in a subject using the approaches described herein may be a combination of any suitable number of low-order optical corrections and/or any suitable number of high-order optical corrections, a single, simple 2 diopter optical correction is illustrated. The same process, however, can be used to define subsurface optical elements for an ophthalmic lens to configure the ophthalmic lens to provide an optical correction to create high-quality vision and/or to inhibit myopia progression (by utilizing any of the myopia inhibiting optical corrections described herein).

FIG. 41 shows a radial variation in units of optical waves of a 2.0 diopter refractive index distribution 510, in accordance with embodiments. The optical waves in this curve correspond to a design wavelength of 562.5 nm. In the illustrated embodiment, the 2.0 diopter refractive index distribution 510 decreases from a maximum of 16.0 waves at the optical axis of an ophthalmic lens down to 0.0 waves at 3.0 mm from the optical axis.

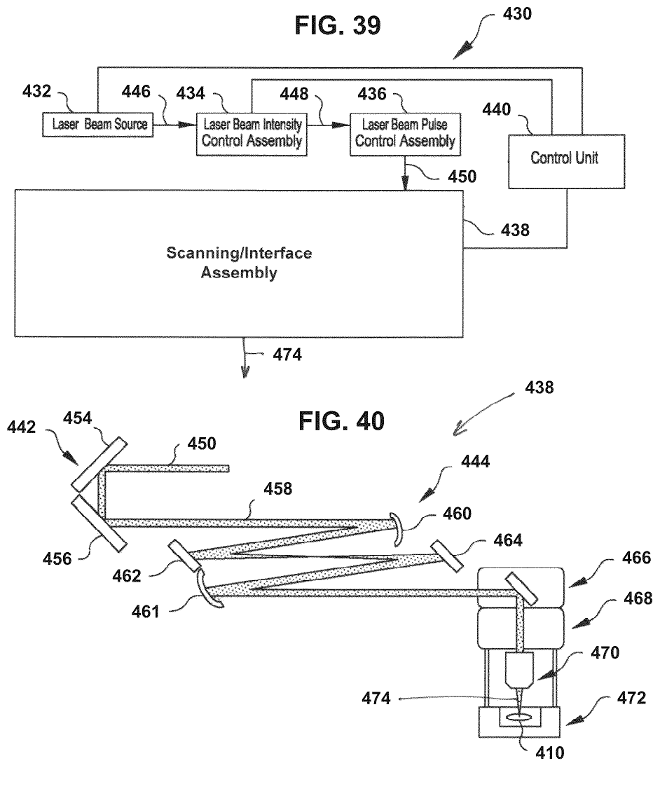

FIG. 42 shows a 1.0 wave phase-wrapped refractive index distribution 512 corresponding to the 2.0 diopter refractive index distribution 510. Each segment of the 1.0 wave phase-wrapped refractive index distribution 512 includes a sloped segment (512a through 512p). Each of all the segments, except the center segment, of the 1.0 wave phase-wrapped refractive index distribution 512 includes an optical phase discontinuity (514b through 514p) with a height equal to 1.0 wave. Each of the sloped segments (512a through 512p) is shaped to match the corresponding overlying segment (510a through 510p) of the 2.0 diopter refractive index distribution 510. For example, sloped segment 512p matches overlying segment 510p; sloped segment 512o is equal to overlying segment 510o minus 1.0 wave; sloped segment 512n is equal to overlying segment 510n minus 2.0 waves; sloped segment 512a is equal to overlying segment 510a minus 15.0 waves. Each sloped segment corresponds to a Fresnel zone.

The 1.0 wave height of each of the optical phase discontinuities (514b through 514p) in the distribution 512 results in diffraction at the design wavelength that provides the same 2.0 diopter refractive correction as the 2.0 diopter refractive distribution 510 while limiting maximum optical phase equal to 1.0 wave.

The 1.0 wave phase-wrapped refractive index distribution 512 requires substantially lower total laser pulse energy to induce in comparison to the 2.0 diopter refractive index distribution 510. The area under the 1.0 wave phase-wrapped refractive index distribution 512 is only about 5.2 percent of the area under the 2.0 diopter refractive index distribution 510.

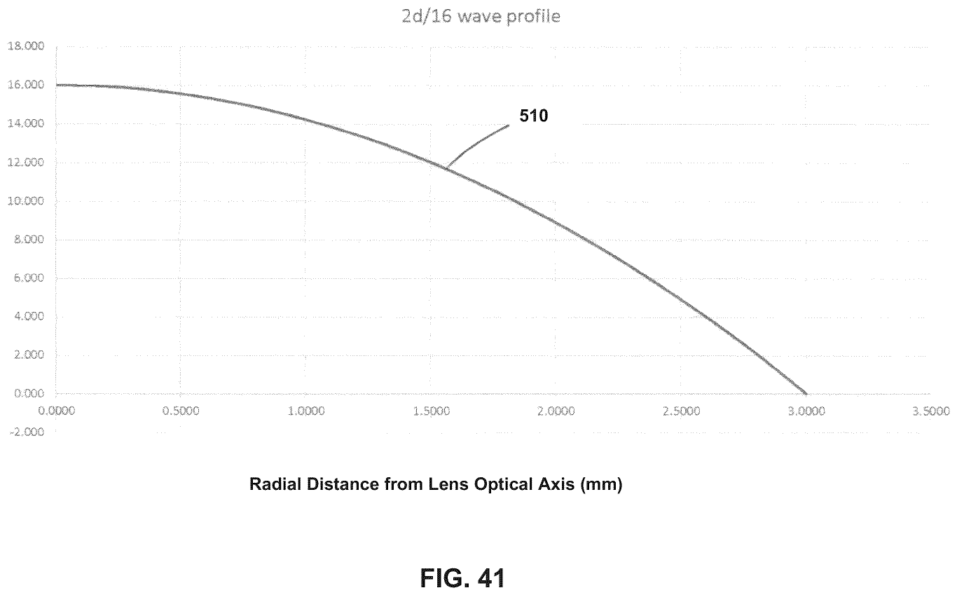

FIG. 43 shows the 1.0 wave phase-wrapped refractive index distribution 512 and an example scaled phase-wrapped refractive index distribution (for a selected maximum wave value) corresponding to the 1.0 wave phase-wrapped refractive index distribution 512. In the illustrated embodiment, the example scaled phase-wrapped refractive index distribution has a maximum wave value of ⅓ wave. Similar scaled phase-wrapped refractive index distributions can be generated for other suitable maximum wave values less than 1.0 wave (e.g., ¾ wave, ⅝ wave, ½ wave, ¼ wave, ⅙ wave). The ⅓ optical wave maximum scaled phase-wrapped refractive index distribution 516 is equal to ⅓ of the 1.0 wave phase-wrapped refractive index distribution 512. The ⅓ optical wave maximum scaled phase-wrapped refractive index distribution 516 is one substitute for the 1.0 wave phase-wrapped refractive index distribution 512 and utilizes a maximum refractive index value that provides a corresponding maximum ⅓ wave optical correction.

The ⅓ optical wave maximum scaled phase-wrapped refractive index distribution 516 requires less total laser pulse energy to induce in comparison with the 1.0 wave phase-wrapped refractive index distribution 512. The area under the ⅓ optical wave maximum scaled phase-wrapped refractive index distribution 516 is ⅓ of the area under the 1.0 wave phase-wrapped refractive index distribution 512. Three stacked layers of the ⅓ wave distribution 516 can be used to produce the same optical correction as the 1.0 wave distribution 512.

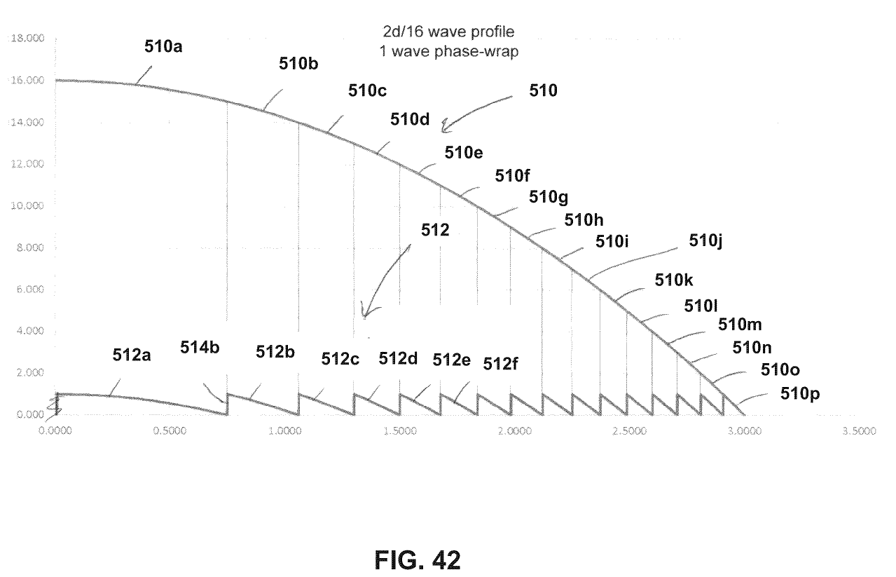

FIG. 44 graphically illustrates diffraction efficiency for near focus 574 and far focus 576 versus optical phase change height. For optical phase change heights less than 0.25 waves, the diffraction efficiency for near focus is only about 10 percent. Near focus diffraction efficiency of substantially greater than 10 percent, however, is desirable to limit the number of layers of the subsurface optical structures that are stacked to generate a desired overall optical correction. Greater optical phase change heights can be achieved by inducing greater refractive index changes in the targeted sub-volumes of the ophthalmic lens 410. Greater refractive index changes in the targeted sub-volumes of the ophthalmic lens 410 can be induced by increasing energy of the laser pulses focused onto the targeted sub-volumes of the ophthalmic lens 410.

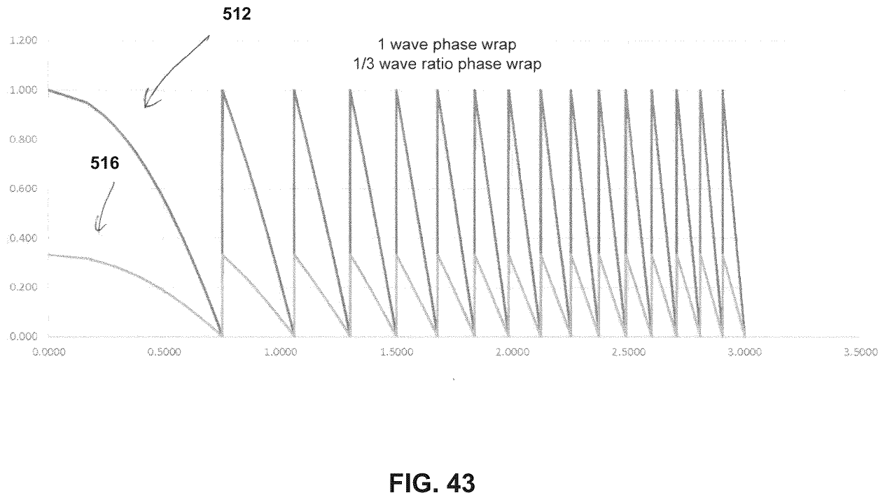

FIG. 45 graphically illustrates an example calibration curve 578 for resulting optical phase change height as a function of laser pulse optical power. The calibration curve 578 shows correspondence between resulting optical phase change height as a function of laser average power for a corresponding laser pulse duration, laser pulse wavelength, laser pulse repetition rate, numerical aperture, material of the ophthalmic lens 410, depth of the targeted sub-volume, spacing between the targeted sub-volumes, scanning speed, and line spacing. The calibration curve 578 shows that increasing laser pulse energy results in increased optical phase change height.

Laser pulse energy, however, may be limited to avoid propagation of damage induced caused by laser pulse energy and/or heat accumulation with the ophthalmic lens 410, or even between the layers of the subsurface optical elements. In many instances, there is no observed damage during formation of the first two layers of subsurface optical elements and damage starts to occur during formation of the third layer of subsurface optical elements. To avoid such damage, the subsurface optical elements can be formed using laser pulse energy below a pulse energy threshold of the material of the ophthalmic lens 410. Using lower pulse energy, however, increases the number of layers of the subsurface optical elements required to provide the desired amount of resulting optical phase change height, thereby adding to the time required to form the total number of subsurface optical elements 412 employed.

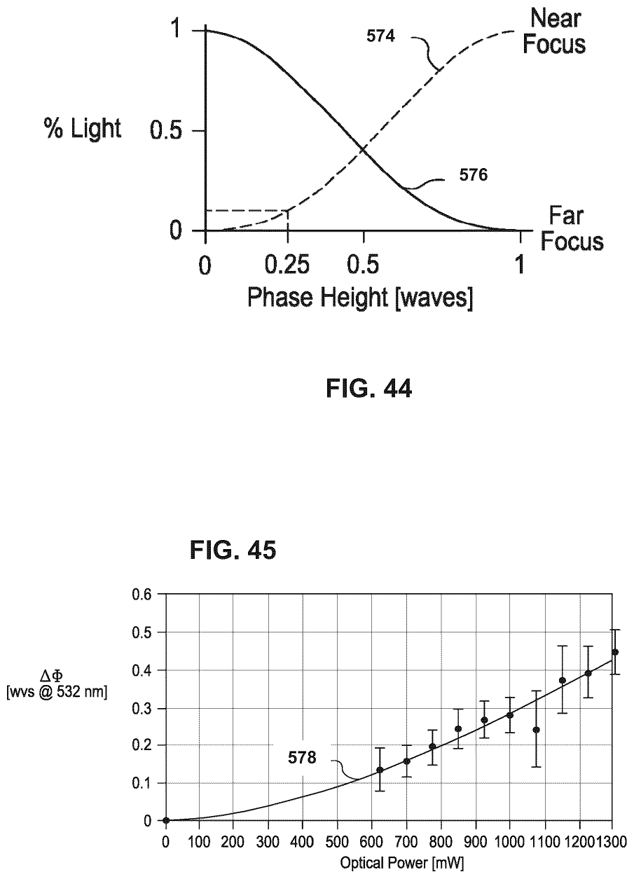

FIG. 46 is a plan view illustration of an ophthalmic lens 410 that includes one or more subsurface optical elements 412 with refractive index spatial variations, in accordance with embodiments. The one or more subsurface elements 12 described herein can be formed in any suitable type of ophthalmic lens including, but not limited to, intra-ocular lenses, contact lenses, corneas, spectacle lenses, and native lenses (e.g., a human native lens). The one or more subsurface optical elements 412 with refractive index spatial variations can be configured to provide a suitable refractive correction configured to create high-quality vision for the patient and/or inhibit progression of myopia as described herein. Additionally, the one or more subsurface optical elements 412 with refractive index spatial variations can be configured to provide a suitable refractive correction for each of many optical aberrations such as astigmatism, myopia, hyperopia, spherical aberrations, coma, and trefoil, as well as any suitable combination thereof.

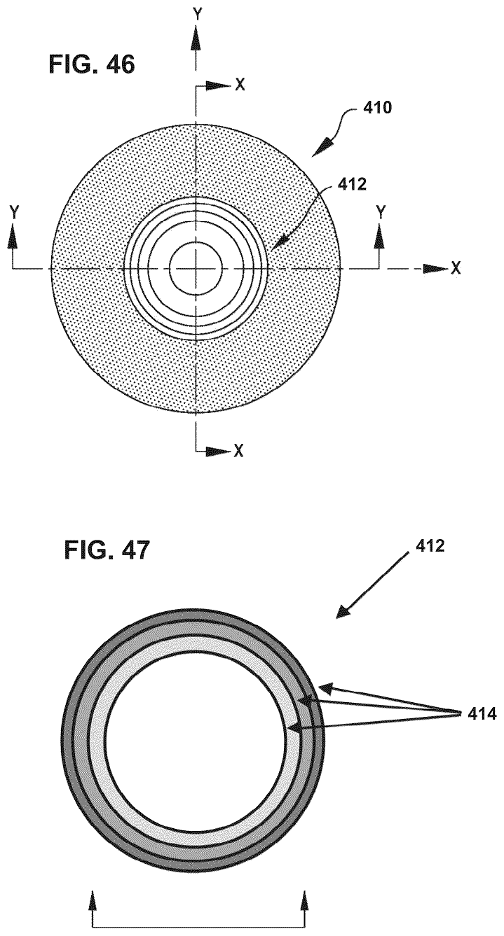

FIG. 47 is a plan view illustration of one of the subsurface optical elements 412 of the ophthalmic lens 410. The illustrated subsurface optical elements 412 occupies a respective volume of the lens 410, which includes associated sub-volumes of the lens 410. In many embodiments, the volume occupied by one of the optical elements 412 includes first, second, and third portions 414. Each of the first, second, and third portions 414 can be formed by focusing suitable laser pulses inside the respective portion 414 so as to induce changes in refractive index in sub-volumes of the lens 410 that make up the respective portion 414 so that each portion 414 has a respective refractive index spatial distribution.

In many embodiments, a refractive index distribution is defined for each portion 414 that forms the subsurface optical structures 412 so that the resulting subsurface optical structures 412 provide a desired optical correction. The refractive index distribution for each portion 414 can be used to determine parameters (e.g., laser pulse power (mW), laser pulse width (fs)) of laser pulses that are focused onto the respective portions 414 to induce the desired refractive index distributions in the portions 414.

While the portions 414 of the subsurface optical structures 412 have a circular shape in the illustrated embodiment, the portions 414 can have any suitable shape and distribution of refractive index variations. For example, a single portion 414 having an overlapping spiral shape can be employed. In general, one or more portions 414 having any suitable shapes can be distributed with intervening spaces so as to provide a desired optical correction for light incident on the subsurface optical structure 412.

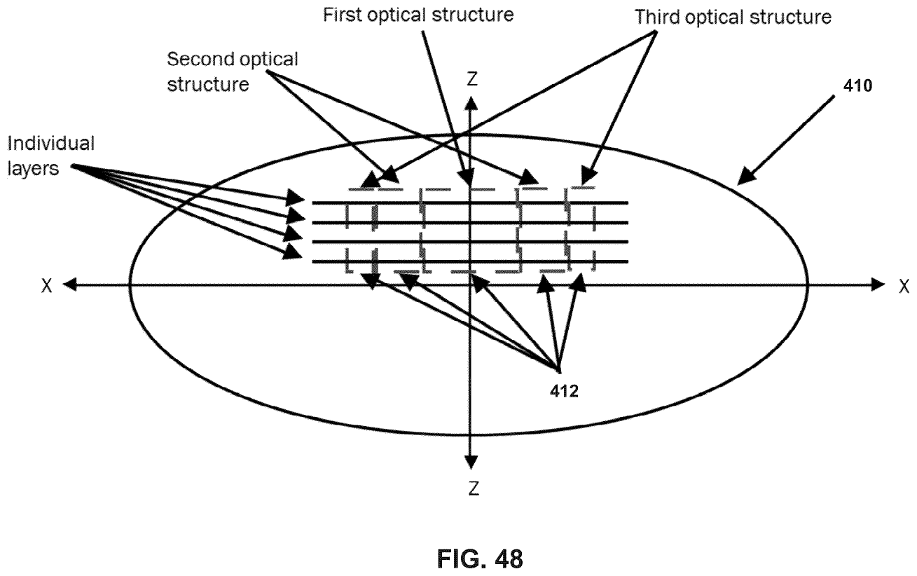

FIG. 48 illustrates an embodiment in which the subsurface optical elements 412 are comprised of several stacked layers that are separated by intervening layer spaces. In the illustrated embodiment, the subsurface optical elements 412 have a spatial distribution of refractive index variations. FIG. 48 is a side view illustration of an example distribution of refractive index variations in the subsurface optical elements 412. In the illustrated embodiment, the subsurface optical elements 412 can be formed using a raster scanning approach in which each layer is sequentially formed starting with the bottom layer and working upward. For each layer, a raster scanning approach can sequentially scan the focal position of the laser pulses along planes of constant Z-dimension while varying the Y-dimension and the X-dimension so that the resulting layers have the flat cross-sectional shapes shown in FIG. 48, which shows a cross-sectional view of the ophthalmic lens 410. In the raster scanning approach, timing of the laser pulses can be controlled to direct each laser pulse onto a targeted sub-volume of the ophthalmic lens 410 and not direct laser pulses onto non-targeted sub-volumes of the ophthalmic lens 410, which include sub-volumes of the ophthalmic lens 10 that do not form any of the subsurface optical elements 412, such as the intervening spaces between the adjacent stacked layers that can form the subsurface optical elements 412.

In the illustrated embodiment, there are three annular subsurface optical elements 412 with distributions of refractive index spatial variations. Each of the illustrated subsurface optical elements 412 has a flat layer configuration and can be comprised of one or more layers. If the subsurface optical structures are comprised of more than one layer, the layers can be separated from each other by an intervening layer spacing. Each of the layers, however, can alternatively have any other suitable general shape including, but not limited to, any suitable non-planar or planar surface. In the illustrated embodiment, each of the subsurface optical elements 412 has a circular outer boundary. Each of the subsurface optical elements 412, however, can alternatively have any other suitable outer boundary shape. Each of the subsurface optical elements 412 can include two or more separate portions 414 with each covering a portion of the subsurface optical elements 412.

Other variations are within the spirit of the present invention. Thus, while the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention, and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

1. An ophthalmic lens configured to inhibit progression of myopia in an eye or reduce myopia in the eye, the ophthalmic lens comprising:
a subsurface optical structure, wherein the ophthalmic lens is formed from a transparent material having a lens material refractive index, wherein the subsurface optical structure comprises refractive indices that differ from the lens material refractive index to provide a chromatic alteration to reduce a rate of axial growth of the eye or decrease an axial length of the eye.

2. The ophthalmic lens of claim 1, wherein the subsurface optical structure comprises a diffractive structure configured to provide the chromatic alteration.

3. The ophthalmic lens of claim 2, wherein the subsurface optical structure is configured to provide a subsurface optical structure diffractive and/or refractive wavefront alteration.

4. The ophthalmic lens of claim 3 comprising an exterior shape configured to provide an exterior shape refractive wavefront alteration.

5. The ophthalmic lens of claim 4, wherein the subsurface optical structure diffractive and/or refractive wavefront alteration and the exterior shape refractive wavefront alteration jointly provide a combined wavefront alteration that provides 0 diopter of optical power.

6. The ophthalmic lens of claim 4, wherein the subsurface optical structure diffractive and/or refractive wavefront alteration and the exterior shape refractive wavefront alteration jointly provide a positive diopter combined wavefront alteration.

7. The ophthalmic lens of claim 4, wherein the subsurface optical structure diffractive and/or refractive wavefront alteration and the exterior shape refractive wavefront alteration jointly provide a negative diopter combined wavefront alteration.

8. The ophthalmic lens of claim 1 comprising an exterior shape configured to provide a zero diopters refractive wavefront alteration.

9. The ophthalmic lens of claim 8, wherein the subsurface optical structure is configured to provide a subsurface optical structure diffractive and/or refractive wavefront alteration.

10. The ophthalmic lens of claim 1, wherein:
the subsurface optical structure provides a wavefront alteration comprising piston regions of different constant whole number optical phase in waves with respect to a reference wavelength and optical phase discontinuity regions;
each of the optical phase discontinuity regions extends between and separates respective two immediately adjacent instances of the piston regions; and
the subsurface optical structure provides the chromatic alteration for wavelengths that differ from the reference wavelength.

11. The ophthalmic lens of claim 1 configured to defocus one or more blue-light wavelengths.

12. The ophthalmic lens of claim 1 comprising a blue-light defocus layer configured to defocus one or more blue-light wavelengths.

13. (canceled)

14. The ophthalmic lens of claim 1, wherein the subsurface optical structure is configured to:
decrease a focal length of a red-light wavelength relative to a focal length of a reference wavelength; and
increase a focal length of a blue-light wavelength relative to the focal length of the reference wavelength.

15. The ophthalmic lens of claim 14, wherein the subsurface optical structure is configured is configured to provide at least a 3.0 diopter diffractive wave front that provides the chromatic alteration.

16. The ophthalmic lens of claim 15, wherein the subsurface optical structure is configured is configured to provide at least a 6.0 diopter diffractive wave front that provides the chromatic alteration.

17. The ophthalmic lens of claim 16, wherein the subsurface optical structure is configured is configured to provide at least a 9.0 diopter diffractive wave front that provides the chromatic alteration.

18. The ophthalmic lens of claim 1, wherein the subsurface optical structure is configured to increase a focal length of a red-light wavelength and decrease the focal length of a blue-light wavelength.

19. The ophthalmic lens of claim 18, wherein the subsurface optical structure is configured to provide at least a −3.0 diopter diffractive wave front that provides the chromatic alteration.

20. The ophthalmic lens of claim 1, wherein:
each of sub-volumes of the subsurface optical structure has a respective refractive index spatial distribution so that the subsurface optical structure provides a wavefront correction comprising piston regions of different constant whole number optical phase in waves with respect to a reference wavelength and optical phase discontinuity regions; and
each of the optical phase discontinuity regions extends between and separates respective two immediately adjacent instances of the piston regions.

21. The ophthalmic lens of claim 20, wherein the subsurface optical structure provides no optical power alteration for the reference wavelength.

22. The ophthalmic lens of claim 20, wherein:
the piston regions comprise a central piston region and annular piston regions that surround the central piston region; and
each of the central piston region and the annular piston regions is configured to have a different constant whole number optical phase in waves with respect to the reference wavelength.

23. The ophthalmic lens of claim 22, wherein the annular piston regions comprise six of the annular piston regions.

24-25. (canceled)

26. The ophthalmic lens of claim 22, wherein each of the optical phase discontinuity regions provides a one optical wave discontinuity with respect to the reference wavelength.

27. The ophthalmic lens of claim 26, wherein the central piston region provides zero waves with respect to the reference wavelength.

28-114. (canceled)
